(19) United States
(12) Patent Application Publication
(10) Pub. No.: US 2018/0151039 A1
(43) Pub. Date: May 31, 2018

(54) Neighborhood Security Cameras

(71) Applicant: Ring Inc., Santa Monica, CA (US)

(72) Inventors: Elliott Lemberger, Santa Monica, CA (US); James Siminoff, Pacific Palisades, CA (US)

(21) Appl. No.: 15/823,449

(22) Filed: Nov. 27, 2017

Related U.S. Application Data
(60) Provisional application No. 62/427,114, filed on Nov. 28, 2016.

(51) Int. Cl. G08B 13/196; H04L 12/28; H04L 29/08; G06K 9/00

(52) U.S. Cl. CPC G08B 13/19639; H04L 12/2825; G06K 9/00221; G08B 13/19608; G08B 13/19656; H04L 67/12

(57) ABSTRACT

Neighborhood security cameras in accordance with various embodiments of the present disclosure are provided. In one embodiment, a security camera device is provided, the security camera device comprising a camera having a field of view, the camera being configured to record image data of the field of view; a communication module; and a processing module operatively connected to the camera and to the communication module, the processing module comprising a processor; and a camera application, wherein the camera application configures the processor to obtain the image data from the camera; and transmit the image data to a backend server using the communication module, such that the image data is publicly accessible via the backend server; wherein the security camera device is configured to provide a public access identifier for accessing, using a client device, the image data recorded by the camera and transmitted to the backend server.

### CROSS-REFERENCE TO RELATED APPLICATIONS

This application claims priority to provisional application Ser. No. 62/427,114, filed on Nov. 28, 2016, the entire contents of which are hereby incorporated by reference.

### TECHNICAL FIELD

The present embodiments relate to security cameras. In particular, the present embodiments relate to improvements in the functionality of security cameras that strengthen the ability of such devices to reduce crime and enhance public safety.

### BACKGROUND

Home safety is a concern for many homeowners and renters. Those seeking to protect or monitor their homes may install one or more security cameras in and/or around their homes.

### SUMMARY

The various embodiments of the present neighborhood security cameras have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

The present embodiments improve the functionality of security cameras in several ways to keep neighborhoods safe and assist law enforcement in fighting crime. The present embodiments also bring together neighborhood residents against a common enemy: crime, thereby reducing crime and fostering a greater sense of community in neighborhoods.

One aspect of the present embodiments includes the realization that, while security cameras provide strong crime deterrence, the video footage that they record is typically only accessible to the party that deployed the cameras. Making the video footage recorded by security cameras accessible to any member of the public would improve the functionality of such cameras by expanding the audience for such video footage, thereby increasing the likelihood that perpetrators of crimes caught on video might be recognized by one or more persons viewing the video footage, which may thereby assist law enforcement in identifying and apprehending such perpetrators.

Another aspect of the present embodiments includes the realization that some neighborhoods are not adequately patrolled by law enforcement and/or private security. One or more security cameras deployed in such neighborhoods could function as a surveillance and early warning system, thereby supplementing and/or serving as a substitute for local police and/or private security.

A further aspect of the present embodiments includes the realization that security cameras may be made more effective by providing complete access to all video footage recorded by a given security camera to each requesting member of the public, rather than granting more limited access to only particular videos recorded by that camera on a case-by-case basis. For example, if the camera has an administrator or other party that receives and grants access requests, it may be more efficient if that party does not have to review access requests on a per-video basis, or send individual invitations with links to video footage on a per-video basis. Thus, it may be advantageous for security cameras located on public property to be configured to provide access to video footage to any requesting member of the public using a public access identifier. There may be further advantages for the public to gain access to live video streams and/or video history, or to receive alerts from the publicly-accessible security camera.

In a first aspect, a security camera device is provided, the security camera device comprising a camera having a field of view, the camera being configured to record image data of the field of view; a communication module; and a processing module operatively connected to the camera and to the communication module, the processing module comprising a processor; and a camera application, wherein the camera application configures the processor to obtain the image data from the camera; and transmit the image data to a backend server using the communication module, such that the image data is publicly accessible via the backend server; wherein the security camera device is configured to provide a public access identifier for accessing, using a client device, the image data recorded by the camera and transmitted to the backend server.

In an embodiment of the first aspect, the public access identifier comprises an alphanumeric code configured to be entered into an application executing on the client device.

In another embodiment of the first aspect, the public access identifier comprises at least one form of automatic identification and data capture (AIDC).

In another embodiment of the first aspect, the AIDC comprises at least one of a barcode, a matrix code, and a bokode.

In another embodiment of the first aspect, the image data publicly accessible via the backend server comprises at least one of a live video stream from the camera and one or more video files recorded by the camera.

Another embodiment of the first aspect further comprises a motion sensor configured to gather information from within the field of view of the camera and generate an output signal.

In another embodiment of the first aspect, the camera application further configures the processor to receive the output signal from the motion sensor and determine, based on the output signal from the motion sensor, whether motion is indicated within the field of view of the camera, and to activate the camera when it is determined that motion is indicated within the field of view of the camera.

In another embodiment of the first aspect, the camera application further configures the processor to perform automatic identification and data capture (AIDC).

In another embodiment of the first aspect, the AIDC comprises at least one of biometrics, voice recognition, facial recognition, three-dimensional facial recognition, and skin texture analysis.

In another embodiment of the first aspect, the camera application further configures the processor to generate an alert when a person of interest is detected using the AIDC.

Another embodiment of the first aspect further comprises a housing configured to contain and protect the camera, the communication module, and the processing module.

Another embodiment of the first aspect further comprises a solar panel configured to provide power to the security camera device.

In another embodiment of the first aspect, the communication module is configured to transmit and receive signals wirelessly.

In a second aspect, a method for accessing video footage recorded by a publicly-accessible security camera device using a client device is provided, the client device including a display, a communication module, and a processing module operatively connected to the display and the communication module, the processing module including a processor and a security camera application, the method comprising receiving, by the client device, an input of a public access identifier corresponding to the publicly-accessible security camera device, wherein the public access identifier is posted adjacent the camera in a public location; transmitting, by the client device to a backend server, a request for access to the video footage recorded by the publicly-accessible security camera device, the request including the public access identifier; and receiving, by the client device from the backend server, an access grant signal with a notification of grant of access to the video footage recorded by the publicly-accessible security camera device.

An embodiment of the second aspect further comprises receiving, by the client device from the backend server, a plurality of links to a plurality of video clips recorded by the publicly-accessible security camera device.

Another embodiment of the second aspect further comprises displaying, on the display of the client device, the plurality of links to the plurality of video clips recorded by the publicly-accessible security camera device.

Another embodiment of the second aspect further comprises receiving, by the client device, a playback request to play a selected one of the plurality of video clips.

Another embodiment of the second aspect further comprises transmitting, by the client device to the backend server, the playback request to play the selected one of the plurality of video clips.

Another embodiment of the second aspect further comprises receiving, by the client device from the backend server, streaming video corresponding to the selected one of the plurality of video clips.

Another embodiment of the second aspect further comprises receiving, by the client device, a user input to share the streaming video with law enforcement.

Another embodiment of the second aspect further comprises transmitting, by the client device to the backend server, an alert request to receive an alert when motion is indicated within a field of view of the security camera device.

Another embodiment of the second aspect further comprises receiving, by the client device from the backend server, the alert when motion is indicated within the field of view of the security camera device.

Another embodiment of the second aspect further comprises receiving, by the client device, a user input to answer the alert.

Another embodiment of the second aspect further comprises receiving, by the client device from the backend server, live streaming video in response to the user input to answer the alert.

Another embodiment of the second aspect further comprises receiving, by the client device, a user input to share the live streaming video with law enforcement.

Another embodiment of the second aspect further comprises transmitting, by the client device to the backend server, an alert request to receive an alert when a person of interest is detected by the security camera device.

Another embodiment of the second aspect further comprises receiving, by the client device from the backend server, the alert when the person of interest is detected by the security camera device.

Another embodiment of the second aspect further comprises receiving, by the client device, a user input to answer the alert.

Another embodiment of the second aspect further comprises receiving, by the client device from the backend server, streaming video in response to the user input to answer the alert.

Another embodiment of the second aspect further comprises receiving, by the client device, a user input to share the streaming video with law enforcement.

In a third aspect, a method for granting access to video footage recorded by a publicly-accessible security camera device is provided, the method comprising receiving, at a backend server from a client device, a request for access to the video footage recorded by the publicly-accessible security camera device, the request including a public access identifier corresponding to the publicly-accessible security camera device, wherein the public access identifier is posted adjacent the publicly-accessible security camera device in a public location; and transmitting, by the backend server to the client device, an access grant signal with a notification of grant of access to the video footage recorded by the publicly-accessible security camera device.

An embodiment of the third aspect further comprises transmitting, by the backend server to the client device, a plurality of links to a plurality of video clips recorded by the publicly-accessible security camera device.

Another embodiment of the third aspect further comprises receiving, by the backend server from the client device, a playback request to play a selected one of the plurality of video clips.

Another embodiment of the third aspect further comprises transmitting, by the backend server to the client device, streaming video corresponding to the selected one of the plurality of video clips.

Another embodiment of the third aspect further comprises receiving, by the backend server from the client device, an alert request to receive an alert when motion is indicated within a field of view of the security camera device.

Another embodiment of the third aspect further comprises transmitting, by the backend server to the client device, the alert when motion is indicated within the field of view of the security camera device.

Another embodiment of the third aspect further comprises receiving, by the backend server from the client device, an alert request to receive an alert when a person of interest is detected by the security camera device.

Another embodiment of the third aspect further comprises transmitting, by the backend server to the client device, the alert when the person of interest is detected by the security camera device.

Another embodiment of the third aspect further comprises receiving, by the backend server from the client device, a request to answer the alert.

Another embodiment of the third aspect further comprises transmitting, by the backend server to the client device, streaming video in response to the request to answer the alert.

Another embodiment of the third aspect further comprises receiving, by the backend server, information about the person of interest.

In another embodiment of the third aspect, the information about the person of interest comprises a photograph.

### BRIEF DESCRIPTION OF THE DRAWINGS

The various embodiments of the present neighborhood security cameras now will be discussed in detail with an emphasis on highlighting the advantageous features. These embodiments depict the novel and non-obvious neighborhood security cameras shown in the accompanying drawings, which are for illustrative purposes only. These drawings include the following figures, in which like numerals indicate like parts:

FIG. 1 is a functional block diagram illustrating a system for streaming and storing A/V content captured by a security camera according to various aspects of the present disclosure;

FIG. 2 is a flowchart illustrating a process for streaming and storing A/V content from a security camera according to various aspects of the present disclosure;

FIG. 3 is a front perspective view of a security camera and environment according to an aspect of the present disclosure;

FIG. 4 is an upper front perspective view of a security camera according to an aspect of the present disclosure;

FIG. 5 is a functional block diagram of the components of the security camera of FIG. 4;

FIG. 6 is a partially exploded rear perspective view of the security camera of FIG. 4, without the mounting apparatus;

FIG. 7 is a front perspective view of the waterproof covers of FIG. 6;

FIG. 8 is a front perspective view of a solar panel configured to provide power to a security camera according to an aspect of the present disclosure;

FIG. 9 is a functional block diagram illustrating a system for providing public access to video footage from a security camera using a public access identifier according to various aspects of the present disclosure;

FIG. 10 is a functional block diagram of one embodiment of a security camera according to various aspects of the present disclosure;

FIG. 11 is a functional block diagram of one embodiment of a backend server according to various aspects of the present disclosure;

FIG. 12 is a flowchart illustrating a process for capturing image data at a security camera for public access according to various aspects of the present disclosure;

FIG. 13 is a flowchart illustrating a process for accessing video footage by a client device using a public access identifier according to various aspects of the present disclosure;

FIG. 14 is a flowchart illustrating a process for granting access to video footage by a server according to various aspects of the present disclosure;

FIG. 15 is a sequence diagram illustrating an embodiment of a process for providing public access to video footage using a public access identifier according to various aspects of the present disclosure;

FIG. 16 is a sequence diagram illustrating an embodiment of a process for providing alerts using a publicly-accessible security camera according to various aspects of the present disclosure;

FIG. 17 is a functional block diagram of a client device on which the present embodiments may be implemented according to various aspects of the present disclosure; and

FIG. 18 is a functional block diagram of a general-purpose computing system on which the present embodiments may be implemented according to various aspects of the present disclosure.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

The embodiments of the present security cameras are described below with reference to the figures. These figures, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unitary piece.

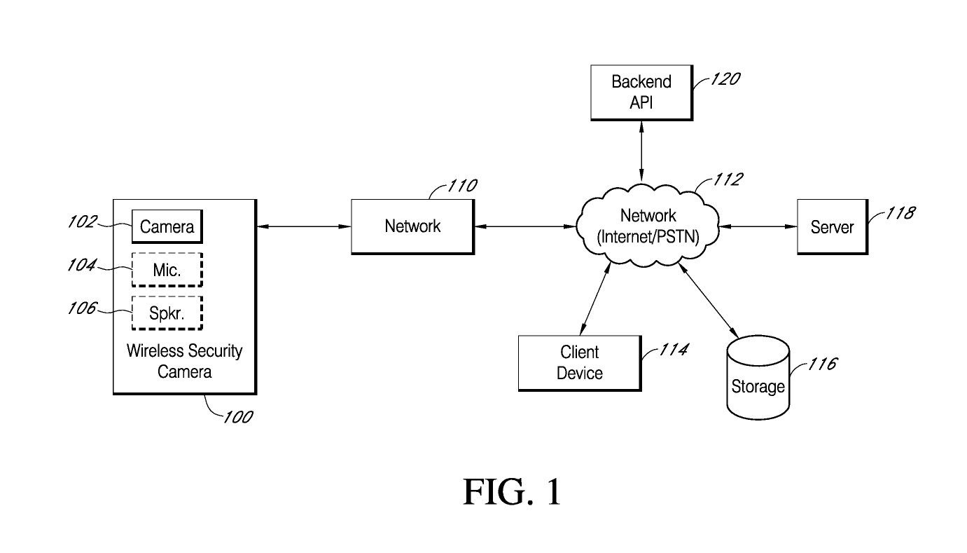

With reference to FIG. 1, the present embodiments include a security camera 100. Security cameras are commonly located within, on, or around the exterior of privately owned structures (not shown), such as dwellings, businesses, storage facilities, etc. The present embodiments, by contrast, contemplate that one or more security cameras may be deployed in public spaces and/or on public property. Any member of the public may access and view the video images recorded by such publicly deployed cameras, thereby increasing the number of viewers of the video images and increasing the likelihood that criminal perpetrators will be identified and apprehended when they are recorded by such publicly deployed cameras. In some embodiments, any member of the public may request to receive an alert from one or more publicly deployed cameras when certain events take place, such as when the camera detects motion, or when the camera detects a person of interest within the field of view of the camera. Although the present embodiments relate to publicly deployed cameras, certain of the present embodiments may also encompass security cameras that are located on private property, but the video images recorded by such privately deployed cameras are nonetheless still accessible by any member of the public.

With reference to FIG. 1, the security camera 100 includes a camera 102, which may comprise, for example, a high definition (HD) video camera, such as one capable of capturing video images at an image display resolution of 720p or better. While not shown in FIG. 1, the security camera 100 may also include other hardware and/or components, such as a housing, one or more motion sensors (and/or other types of sensors), a button, etc. In some embodiments, the security camera 100 may further include a microphone 104 and a speaker 106 to facilitate two-way audio communication. Some embodiments, however, may not include either or both of the microphone 104 and the speaker 106, and may not be capable of two-way audio communication.

With further reference to FIG. 1, the security camera 100 communicates with a network 110, which may be for example a wired and/or wireless network. If the network 110 is wireless, or includes a wireless component, the network 110 may be a Wi-Fi network compatible with the IEEE 802.11 standard and/or other wireless communication standard(s). The network 110 is connected to another network 112, which may comprise, for example, the Internet and/or a public switched telephone network (PSTN). As described below, the security camera 100 may communicate with a user's client device 114 via the network 110 and the network 112 (Internet/PSTN). The user's client device 114 may comprise, for example, a mobile telephone (may also be referred to as a cellular telephone), such as a smartphone, a personal digital assistant (PDA), or another communication and/or computing device. The user's client device 114 comprises a display (not shown) and related components capable of displaying streaming and/or recorded video images. The user's client device 114 may also comprise a speaker and related components capable of broadcasting streaming and/or recorded audio, and may also comprise a microphone. The security camera 100 may also communicate with one or more remote storage device(s) 116 (may be referred to interchangeably as “cloud storage device(s)”), one or more servers 118, and/or a backend API (application programming interface) 120 via the network 110 and the network 112 (Internet/PSTN). While FIG. 1 illustrates the storage device 116, the server 118, and the backend API 120 as components separate from the network 112, it is to be understood that the storage device 116, the server 118, and/or the backend API 120 may be considered to be components of the network 112.

The network 112 may be any wireless network or any wired network, or a combination thereof, configured to operatively couple the above-mentioned modules, devices, and systems as shown in FIG. 1. For example, the network 112 may include one or more of the following: a PSTN (public switched telephone network), the Internet, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a DSL (Digital Subscriber Line) connection, an Ethernet connection, an ISDN (Integrated Services Digital Network) line, a dial-up port such as a V.90, V.34, or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), LTE, VoLTE, LoRaWAN, LPWAN, RPMA, LTE, Cat-“X” (e.g. LTE Cat 1, LTE Cat 0, LTE CatM1, LTE Cat NB1), CDMA (Code Division Multiple Access), TDMA (Time Division Multiple Access), FDMA (Frequency Division Multiple Access), and/or OFDMA (Orthogonal Frequency Division Multiple Access) cellular phone networks, GPS, CDPD (cellular digital packet data), RIM (Research in Motion, Limited) duplex paging network, Bluetooth radio, or an IEEE 802.11-based radio frequency network. The network can further include or interface with any one or more of the following: RS-232 serial connection, IEEE-1394 (Firewire) connection, Fibre Channel connection, IrDA (infrared) port, SCSI (Small Computer Systems Interface) connection, USB (Universal Serial Bus) connection, or other wired or wireless, digital or analog, interface or connection, mesh or Digi® networking.

According to one or more aspects of the present embodiments, when the security camera 100 detects movement, the camera 102 begins capturing video images within a field of view of the camera 102. The security camera 100 may also capture audio through the microphone 104 (in embodiments including the microphone 104). In response to the movement detection, the security camera 100 may send an alert to the user's client device 114 (FIG. 1) via the network 110 and the network 112. The security camera 100 also sends streaming video, and may also send streaming audio, to the user's client device 114. If the user answers the alert, the streaming video may continue on the display of the user's client device 114 until terminated by the user. In some embodiments, two-way audio communication may also be enabled between the person whose movement was detected by the security camera 100 and the user through the security camera 100 and the user's client device 114.

The video images captured by the camera 102 of the security camera 100 (and the audio captured by the microphone 104, in embodiments including the microphone 104,) may be uploaded to the cloud and recorded on the remote storage device 116 (FIG. 1). In some embodiments, the video and/or audio may be recorded on the remote storage device 116 even if the user chooses to ignore the alert sent to his or her client device 114.

With further reference to FIG. 1, the system may further comprise a backend API 120 including one or more components. A backend API (application programming interface) may comprise, for example, a server (e.g. a real server, or a virtual machine, or a machine running in a cloud infrastructure as a service), or multiple servers networked together, exposing at least one API to client(s) accessing it. These servers may include components such as application servers (e.g. software servers), depending upon what other components are included, such as a caching layer, or database layers, or other components. A backend API may, for example, comprise many such applications, each of which communicate with one another using their public APIs. In some embodiments, the API backend may hold the bulk of the user data and offer the user management capabilities, leaving the clients to have very limited state.

The backend API 120 illustrated in FIG. 1 may include one or more APIs. An API is a set of routines, protocols, and tools for building software and applications. An API expresses a software component in terms of its operations, inputs, outputs, and underlying types, defining functionalities that are independent of their respective implementations, which allows definitions and implementations to vary without compromising the interface. Advantageously, an API may provide a programmer with access to an application's functionality without the programmer needing to modify the application itself, or even understand how the application works. An API may be for a web-based system, an operating system, or a database system, and it provides facilities to develop applications for that system using a given programming language. In addition to accessing databases or computer hardware like hard disk drives or video cards, an API can ease the work of programming GUI components. For example, an API can facilitate integration of new features into existing applications (a so-called “plug-in API”). An API can also assist otherwise distinct applications with sharing data, which can help to integrate and enhance the functionalities of the applications.

The backend API 120 illustrated in FIG. 1 may further include one or more services (also referred to as network services). A network service is an application that provides data storage, manipulation, presentation, communication, and/or other capability. Network services are often implemented using a client-server architecture based on application-layer network protocols. Each service may be provided by a server component running on one or more computers (such as a dedicated server computer offering multiple services) and accessed via a network by client components running on other devices. However, the client and server components can both be run on the same machine. Clients and servers may have a user interface, and sometimes other hardware associated with them.

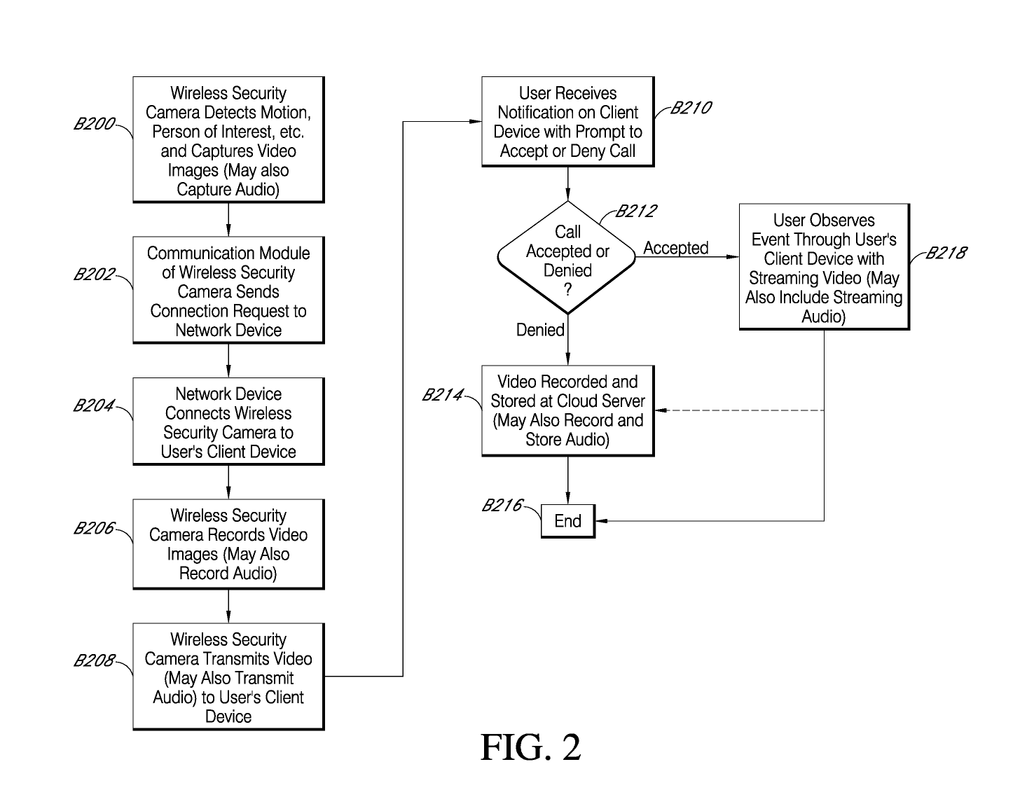

FIG. 2 is a flowchart illustrating a process for streaming and storing A/V content from the security camera 100 according to various aspects of the present disclosure. At block B200, the security camera 100 may be configured to detect motion and capture video images within a field of view of the camera 102. The security camera 100 may also capture audio through the microphone 104. As described above, the security camera 100 may detect a person's presence by detecting motion using the camera 102 and/or a motion sensor. In some embodiments, the security camera 100 may be configured to capture video images when a person of interest is detected, or when a predefined condition for triggering the capture video images is met, as further described below. Also, as described above, the video recording/capture may begin when the person is detected, or may begin earlier, as described below.

At block B202, a communication module of the security camera 100 sends a connection request, via the network 110 and the network 112, to a device in the network 112. For example, the network device to which the request is sent may be a server such as the server 118. The server 118 may comprise a computer program and/or a machine that waits for requests from other machines or software (clients) and responds to them. A server typically processes data. One purpose of a server is to share data and/or hardware and/or software resources among clients. This architecture is called the client-server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes. In another example, the network device to which the request is sent may be an API such as the backend API 120, which is described above.

In response to the request, at block B204 the network device may connect the security camera 100 to the user's client device 114 through the network 110 and the network 112. At block B206, the security camera 100 may record available audio and/or video data using the camera 102, the microphone 104, and/or any other device/sensor available. At block B208, the audio and/or video data is transmitted (streamed) from the security camera 100 to the user's client device 114 via the network 110 and the network 112. At block B210, the user may receive a notification on his or her client device 114 with a prompt to either accept or deny the call.

At block B212, the process determines whether the user has accepted or denied the call. If the user denies the notification, then the process advances to block B214, where the audio and/or video data is recorded and stored at a cloud server. The session then ends at block B216 and the connection between the security camera 100 and the user's client device 114 is terminated. If, however, the user accepts the notification, then at block B218 the user communicates with the visitor through the user's client device 114 while audio and/or video data captured by the camera 102, the microphone 104, and/or other devices/sensors is streamed to the user's client device 114. At the end of the call, the user may terminate the connection between the user's client device 114 and the security camera 100 and the session ends at block B216. In some embodiments, the audio and/or video data may be recorded and stored at a cloud server (block B214) even if the user accepts the notification and communicates with the visitor through the user's client device 114.

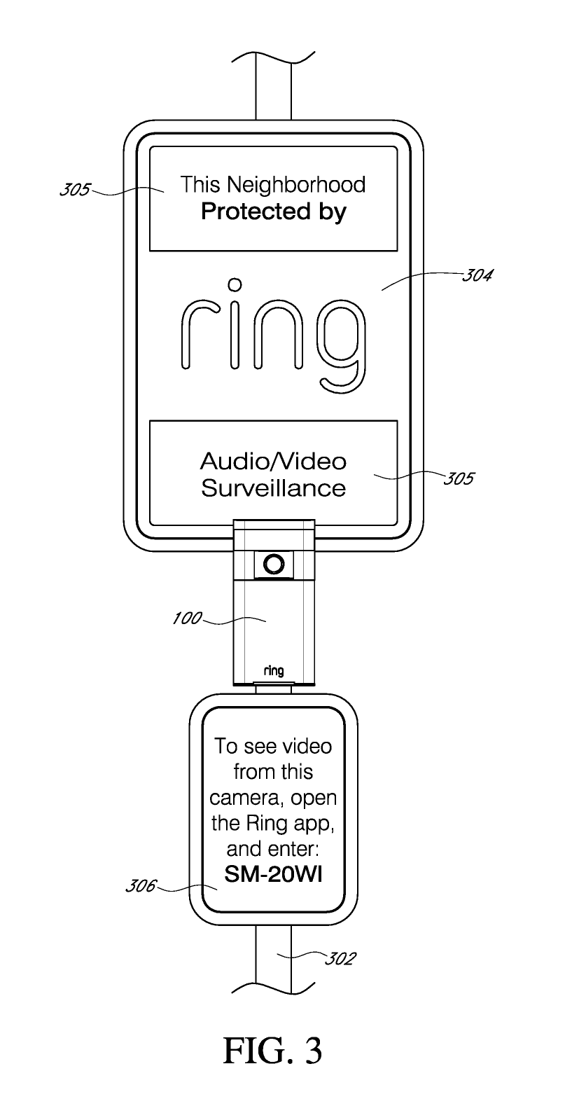

FIG. 3 is a front perspective view of a security camera and environment according to an aspect of the present disclosure. In various embodiments, the security camera 100 may be placed in a public location to capture image and/or audio data, as further described below. In some embodiments, the security camera 100 may be secured to a post 302 or another type of mount. For example, in alternative embodiments the security camera 100 may be secured to a structure, such as a building. A notification sign 304 may be located adjacent the security camera 100. In the illustrated embodiment, the notification sign 304 includes text 305 that notifies persons reading the text 305 that the surrounding neighborhood is protected by audio/video surveillance. Further, instructions 306 for accessing image and/or video data captured by the security camera 100 may also be provided adjacent the security camera 100. In various embodiments, such instructions may include (but are not limited to) directions to download and/or open a computer application using the client device 114 and/or to enter an access identifier (also referred to as “public access identifier”), as further described below. For example, in some embodiments the public access identifier may be an alphanumeric code (e.g., SM-20WI as shown in FIG. 3) configured to be entered into the application executing on the client device 114. In other embodiments, the instructions 306 may include at least one form of automatic identification and data capture (AIDC), such as (but not limited to) a barcode, a matrix code, and/or a bokode that may be read by the client device 114.

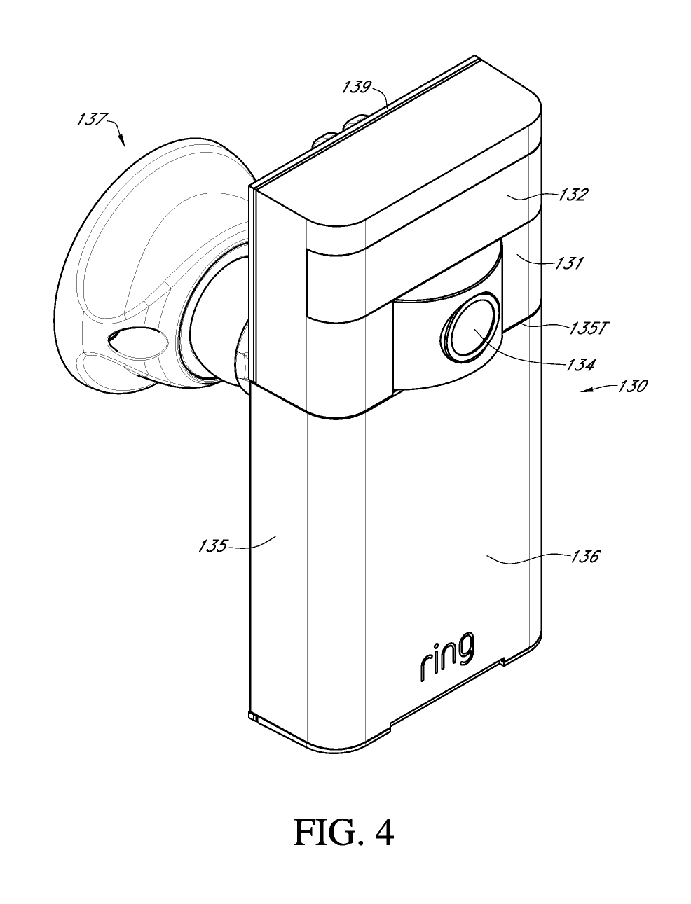

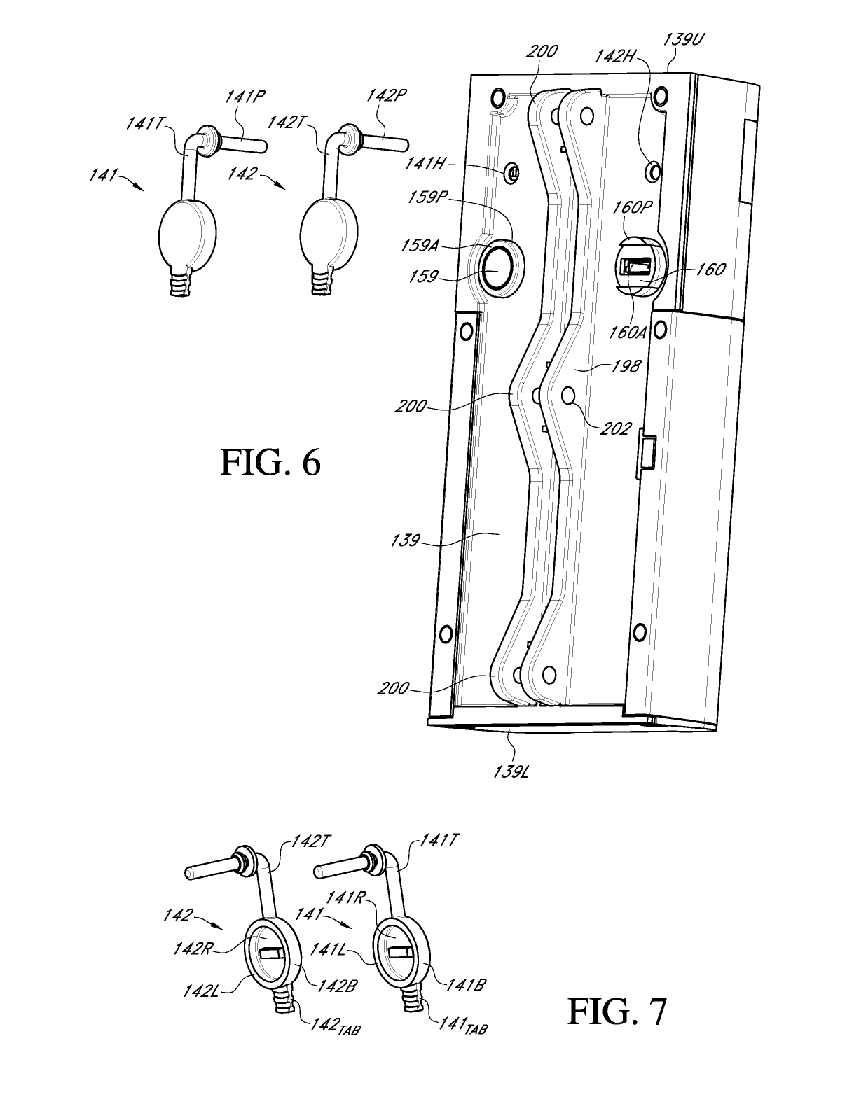

FIGS. 4-7 illustrate a security camera 130 according to an aspect of the present embodiments. FIG. 4 is an upper front perspective view and FIG. 6 is a rear perspective view of the security camera 130 without the mounting apparatus 137. The security camera 130 is configured for use with any of the present methods and/or systems, including those described herein with reference to FIGS. 1-2 and 9-14. The present embodiments, however, can be practiced with one or more security cameras having various features, and are not limited to the security camera 130 shown in FIGS. 4-7.

With reference to FIG. 4, the security camera 130 includes a faceplate 135 mounted to a back plate 139 and an enclosure 131 that engages the faceplate 135. Collectively, the faceplate 135, the back plate 139, and the enclosure 131 form a housing that contains and protects the inner components of the security camera 130. The faceplate 135 has a substantially flat front surface 136. The faceplate 135 may comprise any suitable material, including, without limitation, metals, such as brushed aluminum or stainless steel, metal alloys, or plastics. The faceplate 135 protects the internal contents of the security camera 130 and serves as an exterior front surface 136 of the security camera 130.

With continued reference to FIG. 4, the enclosure 131 engages the faceplate 135 and abuts an upper edge 135T of the faceplate 135. In alternative embodiments, one or more gaps between the enclosure 131 and the faceplate 135 may facilitate the passage of sound and/or light through the security camera 130. The enclosure 131 may comprise any suitable material, but in some embodiments the material of the enclosure 131 preferably permits infrared light to pass through from inside the security camera 130 to the environment and vice versa. The security camera 130 further includes a lens 132. In some embodiments, the lens may comprise a Fresnel lens, which may be patterned to deflect incoming light into one or more infrared sensors located within the security camera 130, as described below. The security camera 130 further includes a camera 134, which captures video data when activated, as described below.

With continued reference to FIG. 4, the enclosure 131 may extend from the front of the security camera 130 around to the back thereof and may fit snugly around a lip (not shown) of the back plate 139. The back plate 139 may comprise any suitable material, including, without limitation, metals, such as brushed aluminum or stainless steel, metal alloys, or plastics. The back plate 139 protects the internal contents of the security camera 130 and serves as an exterior rear surface of the security camera 130. The faceplate 135 may extend from the front of the security camera 130 and at least partially wrap around the back plate 139, thereby allowing a coupled connection between the faceplate 135 and the back plate 139. The back plate 139 may have indentations (not shown) in its structure to facilitate the coupling.

The faceplate 135 may extend from the bottom of the security camera 130 up to just below the camera 134, and connect to the back plate 139 as described above. The lens 132 may extend and curl partially around the side of the security camera 130. The enclosure 131 may extend and curl around the side and top of the security camera 130, and may be coupled to the back plate 139 as described above. The camera 134 may protrude from the enclosure 131, thereby giving it a wider field of view.

With reference to FIG. 6, the security camera 130 further comprises a connector 160, such as a micro-USB or other connector, whereby power and/or data may be supplied to and from the components within the security camera 130. A reset button 159 may be located on the back plate 139, and may make contact with a button actuator (not shown) located within the security camera 130 when the reset button 159 is pressed. When the reset button 159 is pressed, it may trigger one or more functions, as described below. The reset button 159 is located within, and may protrude from, a first opening 159A in the back plate 139. Similarly, the connector 160 is located within, and may protrude from, a second opening 160A in the back plate 139.

With reference to FIG. 4, the security camera 130 may further comprise a mounting apparatus 137 that facilitates mounting the security camera 130 to a surface, such as an exterior wall of a building. The mounting apparatus 137 may couple with the back plate 139, thereby creating an assembly including the security camera 130 and the mounting apparatus 137.

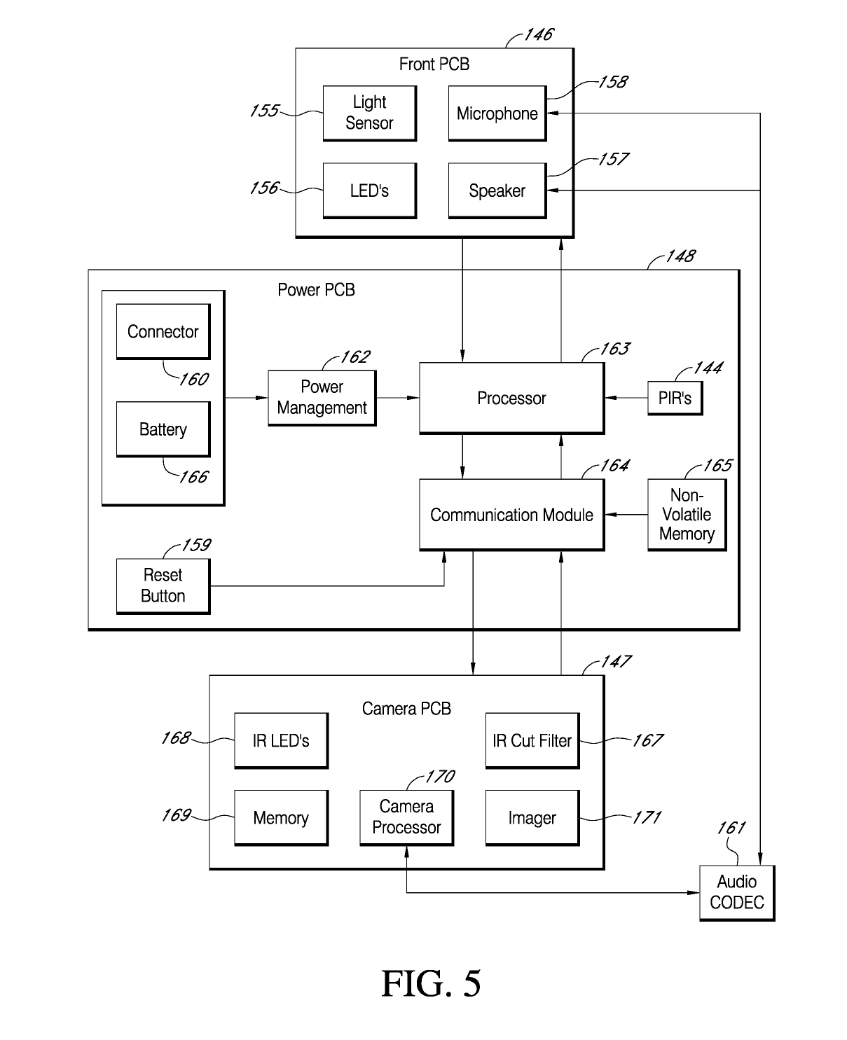

FIG. 5 is a functional block diagram illustrating the components of the security camera 130 of FIG. 4, including components that are located interiorly of the space bounded by the faceplate 135, the back plate 139, and the enclosure 131. With reference to FIG. 5, the interior of the security camera 130 comprises a plurality of printed circuit boards (“PCBs”), including a front PCB 146, a camera PCB 147, and a power PCB 148, each of which is described below.

The camera PCB 147 comprises various components that enable the functionality of the camera 134 of the security camera 130, as described below. Infrared light-emitting components, such as infrared LED's 168, are coupled to the camera PCB 147 and may be triggered to activate when a light sensor detects a low level of ambient light. When activated, the infrared LED's 168 may emit infrared light through the enclosure 131 and/or the camera 134 out into the ambient environment. The camera 134, which may be configured to detect infrared light, may then capture the light emitted by the infrared LED's 168 as it reflects off objects within the camera's 134 field of view, so that the security camera 130 can clearly capture images at night (may be referred to as “night vision”).

The front PCB 146 comprises various components that enable the functionality of the audio and light components, including a light sensor 155, LEDs 156, one or more speakers 157, and a microphone 158. The light sensor 155 may be one or more sensors capable of detecting the level of ambient light of the surrounding environment in which the security camera 130 may be located. The speakers 157 may be any electromechanical device capable of producing sound in response to an electrical signal input. The microphone 158 may be an acoustic-to-electric transducer or sensor capable of converting sound waves into an electrical signal. The front PCB 146 and all components thereof may be electrically coupled to the power PCB 148, thereby allowing data and/or power to be transferred to and from the power PCB 148 and the front PCB 146.

The speakers 157 and the microphone 158 may be coupled to a camera processor 170 on the camera PCB 147 through an audio CODEC 161. For example, the transfer of digital audio from the user's client device 114 and the speakers 157 and the microphone 158 may be compressed and decompressed using the audio CODEC 161, coupled to the camera processor 170. Once compressed by audio CODEC 161, digital audio data may be sent through the communication module 164 to the network 112, routed by one or more servers 118, and delivered to the user's client device 114. When the user speaks, after being transferred through the network 112, digital audio data is decompressed by audio CODEC 161 and emitted to the visitor via the speakers 157.

With continued reference to FIG. 5, the power PCB 148 comprises various components that enable the functionality of the power and device-control components, including a power management module 162, a processor 163 (may also be referred to as “processor,” “CPU,” or “controller”), a communication module 164, and power PCB non-volatile memory 165. In certain embodiments, the power management module 162 may comprise an integrated circuit capable of arbitrating between multiple voltage rails, thereby selecting the source of power for the security camera 130. The battery 166 and/or the connector 160 may each provide power to the power management module 162. The power management module 162 may have separate power rails dedicated to the battery 166 and the connector 160. The power management module 162 may control charging of the battery 166 when the connector 160 is connected to an external source of power, and may also serve as a conduit for data between the connector 160 and the processor 163.

With further reference to FIG. 5, in certain embodiments the processor 163 may comprise an integrated circuit including a processor core, memory, and programmable input/output peripherals. The processor 163 may receive input signals, such as data and/or power, from the PIR sensors 144, the power management module 162, the light sensor 155, the microphone 158, and/or the communication module 164, and may perform various functions as further described below. When the processor 163 is triggered by the PIR sensors 144, the processor 163 may be triggered to perform one or more functions, such as initiating recording of video images via the camera 134. When the light sensor 155 detects a low level of ambient light, the light sensor 155 may trigger the processor 163 to enable “night vision,” as further described below. The processor 163 may also act as a conduit for data communicated between various components and the communication module 164.

With further reference to FIG. 5, the security camera 130 further comprises a communication module 164 coupled to the power PCB 148. The communication module 164 facilitates communication with devices in one or more remote locations, as further described below. The communication module 164 may comprise an integrated circuit including a processor core, memory, and programmable input/output peripherals. The communication module 164 may also be configured to transmit data wirelessly to a remote network device, such as the user's client device 114, the remote storage device 116, and/or the remote server 118, and may include one or more transceivers (not shown). The wireless communication may comprise one or more wireless networks, such as, without limitation, Wi-Fi, cellular, Bluetooth, and/or satellite networks. The communication module 164 may receive inputs, such as power and/or data, from the camera PCB 147, the processor 163, the reset button 159, and/or the power PCB non-volatile memory 165. When the reset button 159 is pressed, the communication module 164 may be triggered to erase any data stored at the power PCB non-volatile memory 165 and/or at the camera PCB memory 169. The communication module 164 may also act as a conduit for data communicated between various components and the processor 163. The power PCB non-volatile memory 165 may comprise flash memory configured to store and/or transmit data. For example, in certain embodiments the power PCB non-volatile memory 165 may comprise serial peripheral interface (SPI) flash memory.

With continued reference to FIG. 5, the power PCB 148 further comprises the connector 160, described above and shown in FIG. 6, and a battery 166. The connector 160 may protrude outward from the power PCB 148 and extend through a hole in the back plate 139 (FIG. 6). The battery 166, which may be a rechargeable battery, may provide power to the components of the security camera 130.

With continued reference to FIG. 5, the power PCB 148 further comprises passive infrared (PIR) sensors 144, which may be secured on or within a PIR sensor holder (not shown) that resides behind the lens 132 (FIG. 4). The PIR sensors 144 may be any type of sensor capable of detecting and communicating the presence of a heat source within their field of view. Further, alternative embodiments may comprise one or more motion sensors either in place of or in addition to the PIR sensors 144. The motion sensors may be configured to detect motion using any methodology, such as a methodology that does not rely on detecting the presence of a heat source within a field of view.

With further reference to FIG. 5, the camera PCB 147 may comprise components that facilitate the operation of the camera 134. For example, an imager 171 may comprise a video recording sensor and/or a camera chip. In one aspect of the present disclosure, the imager 171 may comprise a complementary metal-oxide semiconductor (CMOS) array, and may be capable of recording high definition (720p or better) video files. A camera processor 170 may comprise an encoding and compression chip. In some embodiments, the camera processor 170 may comprise a bridge processor. The camera processor 170 may process video recorded by the imager 171 and audio recorded by the microphone 158, and may transform this data into a form suitable for wireless transfer by the communication module 164 to a network. The camera PCB memory 169 may comprise volatile memory that may be used when data is being buffered or encoded by the camera processor 170. For example, in certain embodiments the camera PCB memory 169 may comprise synchronous dynamic random access memory (SD RAM). IR LED's 168 may comprise light-emitting diodes capable of radiating infrared light. IR cut filter 167 may comprise a system that, when triggered, configures the imager 171 to see primarily infrared light as opposed to visible light. When the light sensor 155 detects a low level of ambient light (which may comprise a level that impedes the performance of the imager 171 in the visible spectrum), the IR LED's 168 may shine infrared light through the security camera 130 enclosure out to the environment, and the IR cut filter 167 may enable the imager 171 to see this infrared light as it is reflected or refracted off of objects within the field of view of the camera 134. This process may provide the security camera 130 with the “night vision” function mentioned above.

The following description illustrates one embodiment of a process that may be performed in connection with the security camera 130 according to an aspect of the present disclosure. For example, the PIR sensors 144 may gather information from within the field of view of the security camera 130. When an object moves into the field of view of one or more of the PIR sensors 144, then the PIR sensors 144 may generate an output signal. The processor 163 may receive the output signal from the PIR sensors 144 and determine, based on the output signal, whether motion is indicated within the field of view of the security camera 130. If it is determined that motion is indicated within the field of view of the security camera 130, the processor 163 may then activate the camera 134 to begin capturing video images from within the field of view of the security camera 130. The processor 163 may also activate the microphone 158 to begin capturing audio from within the vicinity of the security camera 130. The processor 163 may also trigger the communication module 164 to send a request to a network device, such as the server 118. The network device may then connect the security camera 130 to the user's client device 114 through the network 110 and the network 112. The security camera 130 may then stream the video and/or audio from the security camera 130 to the user's client device 114. The user may receive a notification prompting the user to either accept or deny the notification. If the notification is accepted, then the live audio/video data may be displayed on the user's client device 114, thereby allowing the user surveillance from the perspective of the security camera 130. When the user is satisfied with this function, the user may sever the connection, whereby the session ends. If, however, the user denies the notification, or ignores the notification and a specified time interval elapses, then the connection between the security camera 130 and the user's client device 114 is terminated and the audio/video data may be recorded and stored at a cloud server, such that the user may view the audio/video data later at his or her convenience. The security camera 130 may be configured to record for a specified period of time in the event the notification is denied or ignored. If such a time period is set, the security camera 130 may record data for that period of time before ceasing operation, thereby ending the session.

FIG. 6 is a partially exploded rear perspective view of the security camera 130 without the mounting apparatus 137. In FIG. 6, first and second waterproof covers 141, 142 are shown in spaced relation to the security camera 130. The first and second waterproof covers 141, 142 comprise a flexible and resilient material, and are configured to be removably secured over the first opening 159A and the second opening 160A, respectively, in the back plate 139, as shown in FIG. 6. The first and second waterproof covers 141, 142 are thus configured to selectively cover the reset button 159 and the connector 160, respectively, to protect the reset button 159 and the connector 160 from exposure to conditions that might damage or interfere with the performance of the reset button 159 and/or the connector 160, such as water, sunlight, dust or other debris, etc. The material of the first and second waterproof covers 141, 142 is also preferably non-porous so that it presents a barrier to moisture penetration when positioned over the reset button 159 and/or the connector 160. Example materials for the first and second waterproof covers 141, 142 include, without limitation, rubber.

FIG. 7 is a front perspective view of the waterproof covers 141, 142 of FIG. 6. With reference to FIG. 7, each of the waterproof covers 141, 142 comprises a body portion 141B, 142B and a tether portion 141T, 142T that extends from an edge of the respective body portion 141B, 142B. In the illustrated embodiment, the body portion 141B, 142B and the tether portion 141T, 142T of each waterproof cover 141, 142 comprise a single unitary piece. However, in alternative embodiments, the body portions 141B, 142B and the tether portions 141T, 142T may comprise separate pieces.

Each of the body portions 141B, 142B comprises a recess 141R, 142R surrounded by an annular lip 141L, 142L. With reference to FIG. 6, the back plate 139 includes a protruding portion 159P, 160P about each of the first and second openings 159A, 160A, respectively. Each of the protruding portions 159P, 160P is shaped substantially as a disk or cylinder, and each is sized to be matingly received within a respective one of the recesses 141R, 142R. For example, an inner diameter of each of the annular lips 141L, 142L may be approximately equal to an outer diameter of each of the protruding portions 159P, 160P, such that friction maintains the waterproof covers 141, 142 in position over the reset button 159 and the connector 160, respectively, but the body portions 141B, 142B may be easily separated from the reset button 159 and the connector 160, respectively, with force applied by an operator's fingers.

With reference to FIG. 6, each tether portion 141T, 142T comprises a post 141P, 142P that is received within a respective hole 141H, 142H in the back plate 139. Engagement of the posts 141P, 142P within their respective holes 141H, 142H secures each of the first and second waterproof covers 141, 142 to the back plate 139 even when the first and second waterproof covers 141, 142 are lifted away from the first opening 159A and the second opening 160A, respectively. Each of the first and second waterproof covers 141, 142 further comprises a tab 141_{TAB}, 142_{TAB} that extends from an edge of the body portion 141B, 142B opposite the tether portion 141T, 142T. The tabs 141_{TAB}, 142_{TAB} provide convenient grips for the operator to grasp with thumb and forefinger when lifting the first and second waterproof covers 141, 142 away from the first and second openings 159A, 160A, respectively.

With reference to FIG. 6, the mating bracket portion 198 on the back plate 139 includes three sets of the spaced brackets 200. A first set of the spaced brackets 200 is located adjacent an upper end 139U of the back plate 139, a second set of the spaced brackets 200 is located adjacent a lower end 139L of the back plate 139, and a third set of the spaced brackets 200 is located between the first and second sets of the spaced brackets 200. A variety of complementary brackets (not illustrated) may be mated to any of the first, second, and third sets of the spaced brackets 200, so that the security camera 130 advantageously can be mounted in any of three positions along the length of the back plate 139. This configuration further expands the range of positions and viewing angles with which the security camera 130 can be secured to the mounting surface. Further, the mating bracket portion 198 may include a plurality of spaced brackets 200 defining coaxial openings 202. In the illustrated embodiment, the bracket portion 198 includes two spaced brackets 200, but in alternative embodiments any number of spaced brackets 200 may be provided.

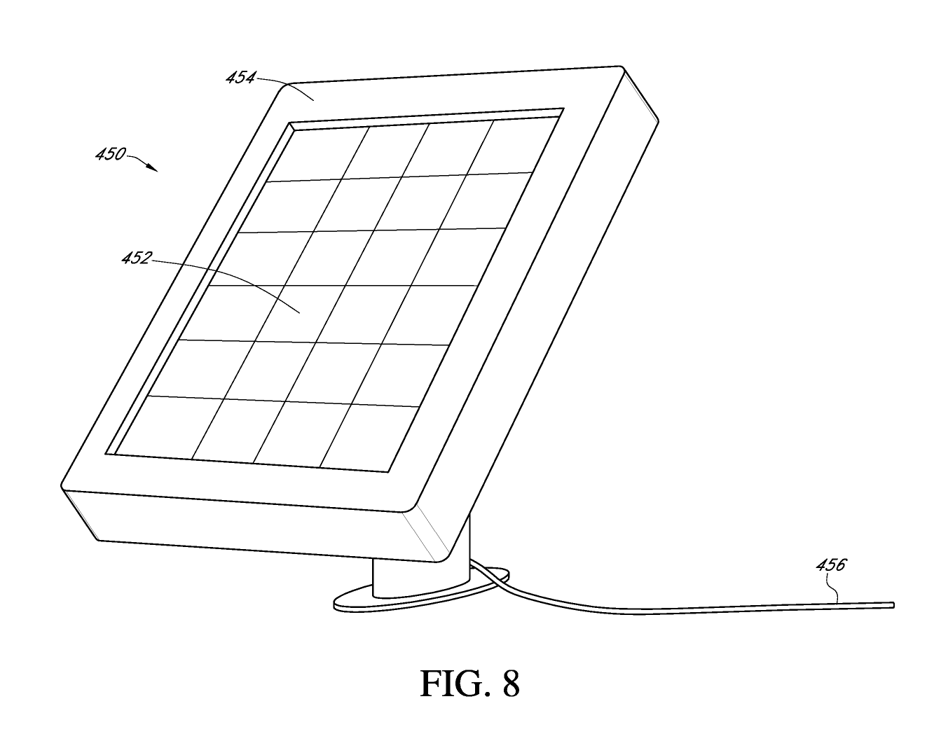

Some of the present embodiments may include an external solar panel for providing power to the security camera 130. For example, FIG. 8 illustrates a solar panel 450 comprising a plurality of photovoltaic modules 452 including a packaged, connected assembly of solar cells. The solar modules 452 use light energy (photons) from the sun to generate electricity through the photovoltaic effect. The solar modules 452 may include, for example, wafer-based crystalline silicon cells and/or thin-film cells based on, for example, cadmium telluride or silicon. The solar cells are secured to a structural (load carrying) member 454, and may be rigid or semi-flexible. In one non-limiting example, the total output power of the solar panel 450 may range from about 0.1 watts to about 5 watts, such as from about 0.5 watts to about 1 watt.

The solar panel 450 may include a power cable 456 having a connector (not shown) at a distal end. The connector may comprise, for example, a micro-USB or other connector configured to be received by the connector 160 of the security camera 130. When the solar panel 450 is connected to the security camera 130 via the power cable 456 and the connectors, the solar panel 450 may provide power to the security camera 130 to recharge the battery 166 and/or to power other components of the security camera 130.

As discussed above, one aspect of the present embodiments includes the realization that, while security cameras provide strong crime deterrence, the video footage that they record is typically only accessible to the party that deployed the cameras. Making the video footage (may also be referred to as “image data”) recorded by security cameras accessible to any member of the public would improve the functionality of such cameras by expanding the audience for such video footage, thereby increasing the likelihood that perpetrators of crimes caught on video might be recognized by one or more persons viewing the video footage, which may thereby assist law enforcement in identifying and apprehending such perpetrators. In addition, another aspect of the present embodiments includes the realization that some neighborhoods are not adequately patrolled by law enforcement or private security. One or more security cameras deployed in such neighborhoods could function as a surveillance and early warning system, thereby supplementing and/or serving as a substitute for local police and private security. The present embodiments provide these advantages and enhancements, as further described below.

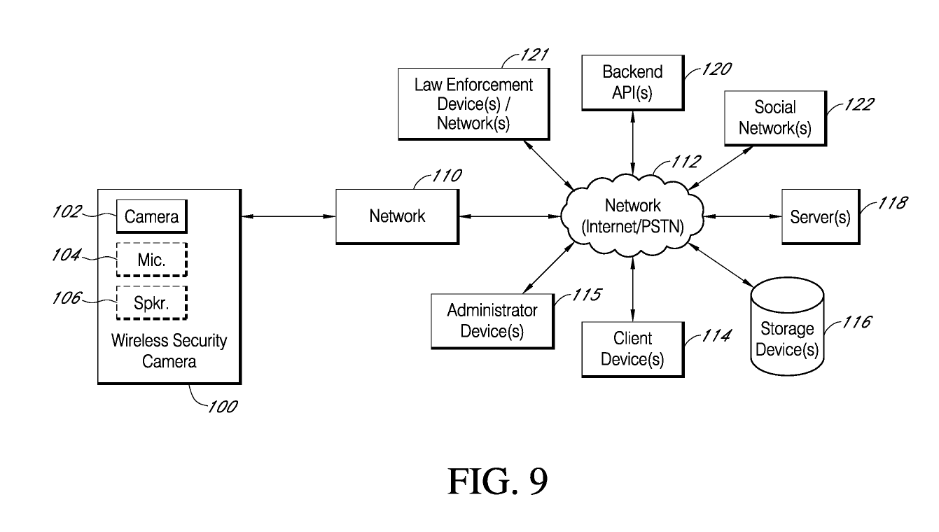

FIG. 9 is a functional block diagram illustrating a system for providing public access to video footage recorded by a security camera using a public access identifier according to various aspects of the present disclosure. As discussed above, the security camera 100 (which may be, for example, the security camera 130 described with reference to FIGS. 4-7) may be placed in a public location to capture image data using the camera 102 and/or audio data using the microphone 104. In some embodiments, the security camera 100 may also include a speaker 106 that, together with the microphone 104, allows for two-way audio communication between a person remotely connected to the security camera 100 and a person in the vicinity of the security camera 100. As also discussed above, the security camera 100 may be connected to the network (Internet/PSTN) 112 using the network 110. In alternative embodiments, the security camera 100 may be connected to the network (Internet/PSTN) 112 via a wired network (not shown), or connected directly to the network (Internet/PSTN) 112 without any intervening network.

In various embodiments, initial setup and/or control of settings of the security camera 100 may be configured by one or more administrators using one or more administrator device(s) 115. The administrator device(s) 115 may be similar to, or the same as, the client device(s) 114 (as described above). Administrators and/or administrator device(s) 115, however, may have advanced permissions with respect to the security camera 100 that the client device(s) 114 (and users of the client device(s) 114) may not have. Such advanced permissions may include (but not be limited to) deleting video footage recorded by the security camera 100, changing and resolving settings related to network connectivity, notifications, camera sensitivity, and/or software updates. In some embodiments, an administrator may approve or deny user requests for access to one or more of the security cameras 100.

With further reference to FIG. 9, audio and/or image data captured by the security camera 100 may be transmitted to one or more storage device(s) 116, one or more server(s) 118 (also referred to as “backend server(s)”), and/or one or more backend API(s) 120, as further discussed below. In various embodiments, image data may comprise image sensor data such as (but not limited to) exposure values and data regarding pixel values for a particular size grid. Further, image data may comprise converted image sensor data for standard image file formats such as (but not limited to) JPEG, JPEG 2000, TIFF, BMP, or PNG. In addition, image data may also comprise data related to video, where such data may include (but is not limited to) image sequences, frame rates, and the like. Moreover, image data may include data that is analog, digital, uncompressed, compressed, and/or in vector formats. Image data may take on various forms and formats as appropriate to the requirements of a specific application in accordance with the present embodiments.

In further reference to FIG. 9, in some embodiments the backend server 118 may use the image data to provide video footage to any of the client device(s) 114 upon receipt of one or more requests for access that include a public access identifier, as further described below. The security camera 100 may also be configured to perform automatic identification and data capture (AIDC), such as (but not limited to) at least one of biometrics, voice recognition, facial recognition, three-dimensional facial recognition, and/or skin texture analysis, to identify a person of interest and generate at least one alert (may also be referred to as a “notification”). For example, in some embodiments, the security camera 100, the backend server 118, and/or the backend API 120 may perform facial recognition to determine if a person of interest is recognized. In various embodiments, the image data captured by the security camera 100 may be processed to compare facial features to a database, such as (but not limited to) one or more criminal registries. Further, various members of the public may submit photos of a person of interest and be alerted when images of that person are captured by the security camera 100. In further embodiments, one or more law enforcement agencies may also be alerted, such as through an alert sent to one or more law enforcement device(s)/network(s) 121, when a person of interest is detected by the security camera 100. In some embodiments, one or more social network(s) 122 may be alerted and/or image data may be posted to such social network(s) 122. The social network(s) 122 may include any social media service or platform that uses computer-mediated tools that allow participants to create, share, and/or exchange information in virtual communities and/or networks, such as (but not limited to) social networking websites and/or applications running on participant devices. Non-limiting examples of social networks include Facebook, Twitter, Snapchat, and Nextdoor.

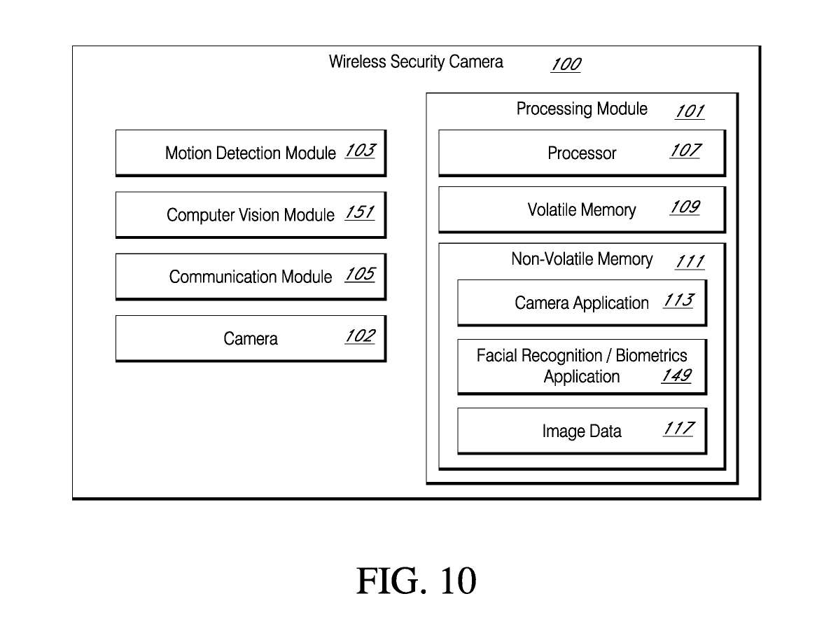

In continued reference to FIG. 9, the security camera 100 may include the camera 102, the microphone 104, and the speaker 106 as discussed above. Further, with reference to FIG. 10, the security camera 100 may also include a processing module 101 that is operatively connected to a motion detecting module 103 and a communication module 105. The processing module 101 may comprise a processor 107, a volatile memory 109, and a non-volatile memory 111 that includes a camera application 113. The camera application 113 may be used to configure the processor 107 to perform various functions, including (but not limited to) detecting motion of a person within the camera 102's field of view using the motion detecting module 103, recording image data 117 of the person using the camera 102, and transmitting the obtained image data 117 to the backend server 118 using the communication module 105, as further discussed below. In some embodiments, the motion detecting module 103 may comprise (but is not limited to) at least one passive infrared (PIR) sensor. The motion detecting module 103 may further comprise the camera 102, instead of or in addition to a discrete motion detecting device. Further, in some embodiments, the communication module 105 may comprise (but is not limited to) one or more transceivers and/or wireless antennas configured to transmit and receive wireless signals.

In the illustrated embodiment of FIG. 10, the processing module 101, the motion detecting module 103, and the communication module 105 are represented by separate boxes. The graphical representation depicted in FIG. 10 is, however, merely one example, and is not intended to indicate that any of the processing module 101, the motion detecting module 103, and/or the communication module 105 are necessarily physically separate from one another, although in some embodiments they might be. In other embodiments, however, the structure and/or functionality of any or all of these components may be combined. For example, either or both of the motion detecting module 103 and the communication module 105 may include its own processor, volatile memory, and/or non-volatile memory.

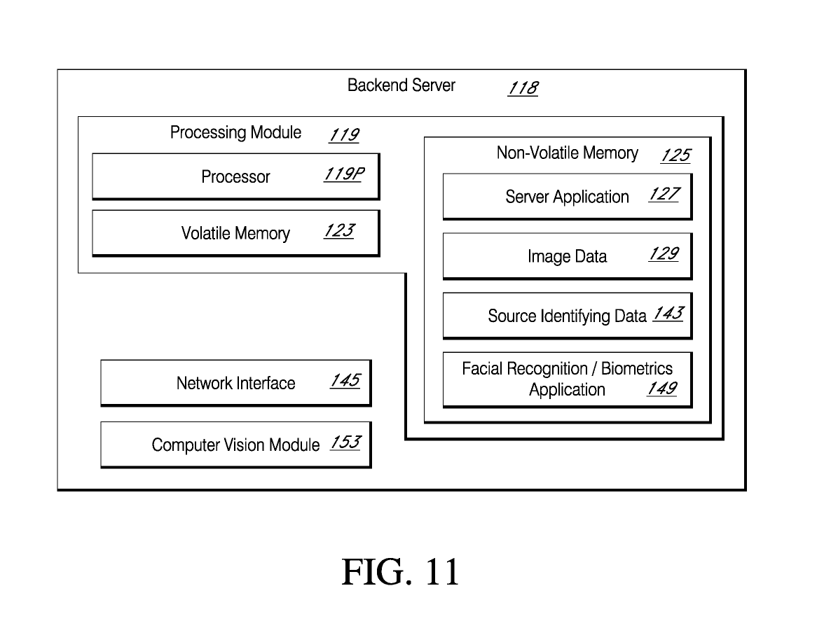

FIG. 11 is a functional block diagram of an embodiment of the backend server 118 according to an aspect of the present disclosure. The backend server 118 may include a processing module 119 comprising a processor 119P, a volatile memory 123, and a non-volatile memory 125 that includes a server application 127. The server application 127 may be used to configure the processor 119P to perform various functions, including (but not limited to) receiving image data 129 and source identifying data 143 from the security camera 100. In some embodiments, the source identifying data 143 may comprise the public access identifier associated with the security camera 100. The backend server 118 may also include a network interface 145 for communicating over the network 112 (Internet/PSTN).

While FIG. 9 illustrates only a single security camera 100, various embodiments may comprise more than one security camera 100, such as a network of security cameras 100. For example, multiple security cameras 100 may be located in a neighborhood and/or distributed across multiple neighborhoods. It is contemplated that any member of the public may request access to any of these cameras 100, and may be granted access to view the video footage captured by one or more of these cameras 100, and/or may receive alerts, and view live streaming video, from one or more of these cameras 100, as described below.

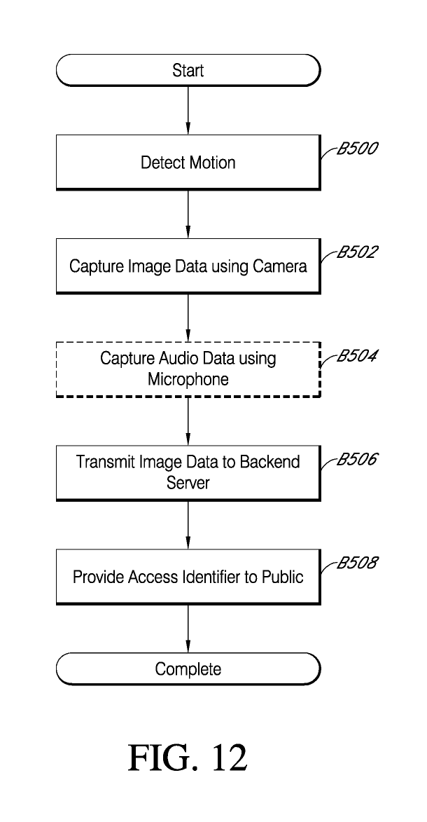

FIG. 12 is a flowchart illustrating a process for capturing image data at a security camera 100 for public access according to various aspects of the present disclosure. The process may include detecting motion (block B500) of a person within the field of view of the camera 102. In some embodiments, the camera 102 itself may detect motion by analyzing image data captured within its field of view. In further embodiments, the security camera 100 may include at least one motion sensor, such as one or more passive infrared (PIR) sensors 144 (FIG. 5), or any other type of motion sensor(s). In such embodiments, the motion sensor(s) may be configured to gather information from within the field of view of the camera 102 and generate an output signal. The camera application 113 (FIG. 10) may further configure the processor 107 to receive the output signal from the motion sensor and determine, based on the output signal from the motion sensor, whether motion is indicated within the field of view of the camera 102, and to activate the camera 102 when it is determined that motion is indicated within the field of view of the camera 102.

For example, the PIR sensors 144 (FIG. 5) may be operatively connected to the power PCB 148 to turn the camera 102 on or off. When motion is detected by the PIR sensors 144 within the field of view of the camera 102, the PIR sensors 144 may send a signal to the power PCB 148. In response to the signal from the PIR sensors 144, the camera 102 and/or the IR LEDs 168 may be switched on. In some embodiments, when the motion is no longer detected, and/or when a timer expires, the camera 102 may turn itself off. In this manner, the camera 102 is only turned on in response to the PIR sensors 144 detecting motion. This aspect may not only detect motion but also further enhance the power efficiency of the security camera 100 by conserving battery power in comparison to an embodiment in which the camera 102 is always on. In addition, the security camera 100 may also be attached to a solar panel (FIG. 8) to provide power to the security camera 100 and/or to recharge the battery 166, as discussed above. In alternative embodiments, the security camera 100 may be connected to a power source, such as AC mains. In such embodiments, the security camera 100 may not include the battery 166. Also, in such embodiments, the security camera 100 may use the camera 102 for motion detection, and the camera 102 may always be powered on and recording.

In further reference to FIG. 12, when motion is detected, the process may also include capturing (block B502) image data using the camera 102, and in some embodiments may also include capturing (block B504) audio data using the microphone 104. In various embodiments, the image data (and/or audio data) may be transmitted (block B506) to the backend server 118 using the communication module 164 (FIG. 5), as described above. Further, the process may include providing (block B508) an access identifier to the public (also referred to as “public access identifier”) for accessing video footage captured by the security camera 100. For example, the security camera 100 may provide instructions 306 (FIG. 3) that include the public access identifier, as described above. In some embodiments, such instructions may be provided in a variety of public notices that may be posted near and/or adjacent to the security camera 100. In some embodiments, the public access identifier may comprise at least one form of AIDC such as (but not limited to) at least one barcode, matrix code, or bokode, as described above.

In some embodiments, the security camera 100 or the backend server 118, or both, may be configured to identify a person in the field of view of the security camera 100 using biometric data. For example, with reference to FIGS. 10 and 11, either or both of the security camera 100 and the backend server 118 may include a facial recognition/biometrics application 149. With respect to the security camera 100, the facial recognition/biometrics application 149 may be executed by the processor 107 out of the non-volatile memory 111, and may be used in connection with the image data 117 to identify persons in the field of view of the security camera 100. With respect to the backend server 118, the facial recognition/biometrics application 149 may be executed by the processor 119 out of the non-volatile memory 125, and may be used in connection with the image data 129 to identify persons in the field of view of the security camera 100.

Some of the present embodiments may comprise computer vision for one or more aspects, such as identifying persons in the field of view of the security camera 100. Computer vision includes methods for acquiring, processing, analyzing, and understanding images and, in general, high-dimensional data from the real world in order to produce numerical or symbolic information, e.g. in the form of decisions. Computer vision seeks to duplicate the abilities of human vision by electronically perceiving and understanding an image. Understanding in this context means the transformation of visual images (the input of the retina) into descriptions of the world that can interface with other thought processes and elicit appropriate action. This image understanding can be seen as the disentangling of symbolic information from image data using models constructed with the aid of geometry, physics, statistics, and learning theory. Computer vision has also been described as the enterprise of automating and integrating a wide range of processes and representations for vision perception.

Typical functions and components (e.g. hardware) found in many computer vision systems are described in the following paragraphs. The present embodiments may include at least some of these aspects. For example, with reference to FIG. 10, embodiments of the present security camera 100 may include a computer vision module 151. The computer vision module 151 may include any of the components (e.g. hardware) and/or functionality described herein with respect to computer vision, including, without limitation, one or more cameras, sensors, and/or processors. In some embodiments, the camera 102, the microphone 104, the processor 163, and/or the camera processor 170 may be components of the computer vision module 151. Further, in some embodiments the functions of the computer vision module 151 may be offloaded to the backend server 118 (FIG. 11), which may include a computer vision module 153 in addition to (or instead of) the computer vision module 151 of the security camera 100.

Image acquisition—A digital image is produced by one or several image sensors, which, besides various types of light-sensitive cameras, may include range sensors, tomography devices, radar, ultra-sonic cameras, etc. Depending on the type of sensor, the resulting image data may be a 2D image, a 3D volume, or an image sequence. The pixel values may correspond to light intensity in one or several spectral bands (gray images or color images), but can also be related to various physical measures, such as depth, absorption or reflectance of sonic or electromagnetic waves, or nuclear magnetic resonance.

Pre-processing—Before a computer vision method can be applied to image data in order to extract some specific piece of information, it is usually beneficial to process the data in order to assure that it satisfies certain assumptions implied by the method. Examples of pre-processing include, but are not limited to re-sampling in order to assure that the image coordinate system is correct, noise reduction in order to assure that sensor noise does not introduce false information, contrast enhancement to assure that relevant information can be detected, and scale space representation to enhance image structures at locally appropriate scales.

Feature extraction—Image features at various levels of complexity are extracted from the image data. Typical examples of such features are: Lines, edges, and ridges; Localized interest points such as corners, blobs, or points; More complex features may be related to texture, shape, or motion.

Detection/segmentation—At some point in the processing a decision may be made about which image points or regions of the image are relevant for further processing. Examples are: Selection of a specific set of interest points; Segmentation of one or multiple image regions that contain a specific object of interest; Segmentation of the image into nested scene architecture comprising foreground, object groups, single objects, or salient object parts (also referred to as spatial-taxon scene hierarchy).

High-level processing—At this step, the input may be a small set of data, for example a set of points or an image region that is assumed to contain a specific object. The remaining processing may comprise, for example: Verification that the data satisfy model-based and application-specific assumptions; Estimation of application-specific parameters, such as object pose or object size; Image recognition—classifying a detected object into different categories; Image registration—comparing and combining two different views of the same object.

Decision making—Making the final decision required for the application, for example match/no-match in recognition applications.

One or more of the present embodiments may include a vision processing unit (not shown separately, but may be a component of the computer vision module(s) 151/153). A vision processing unit is an emerging class of microprocessor; it is a specific type of AI (artificial intelligence) accelerator designed to accelerate machine vision tasks. Vision processing units are distinct from video processing units (which are specialized for video encoding and decoding) in their suitability for running machine vision algorithms such as convolutional neural networks, SIFT, etc. Vision processing units may include direct interfaces to take data from cameras (bypassing any off-chip buffers), and may have a greater emphasis on on-chip dataflow between many parallel execution units with scratchpad memory, like a manycore DSP (digital signal processor). But, like video processing units, vision processing units may have a focus on low precision fixed point arithmetic for image processing.

Further examples of AIDC and/or computer vision that can be used in the present embodiments to identify a person include, without limitation, biometrics. Biometrics refers to metrics related to human characteristics. Biometric identifiers are the distinctive, measurable characteristics used to label and describe individuals. Biometric identifiers can be physiological characteristics and/or behavioral characteristics. Physiological characteristics may be related to the shape of the body. Examples include, but are not limited to, facial recognition, three-dimensional facial recognition, skin texture analysis, and odor/scent recognition. Behavioral characteristics may be related to the pattern of behavior of a person, including, but not limited to, gait, and voice recognition.

The present embodiments may use any one, or any combination of more than one, of the foregoing biometrics to identify a person in the field of view of the security camera 100. For example, the computer vision module 151, and/or the camera 102, and/or the processor 107 may receive information about the person using any one, or any combination of more than one, of the foregoing biometrics. The received information (through AIDC and/or computer vision) may be compared to stored information about one or more persons. For example, the received information may be sent to one or more network devices, such as the backend server 118 and/or the backend API 120, in an identity query signal. The one or more network devices may then compare information in the identity query signal about the person detected in the area about the security camera 100 with information from one or more sources. These information sources may include one or more databases and/or services. For example, a database and/or service may include a database of persons who are wanted in connection with crimes. If a match is found, one or more actions may be taken, such as transmitting an alert to the law enforcement device(s)/network(s) 121 (FIG. 9). In another example, a database and/or service may include a sex offender registry. If a match is found, one or more actions may be taken, such as transmitting an alert to any persons who have requested to receive alerts when a registered sex offender is detected by the security camera 100. The databases, services, alerts, and other types of actions that can be used in connection with the present embodiments are limitless, and the foregoing examples are neither exhaustive nor intended to limit the present embodiments in any way.

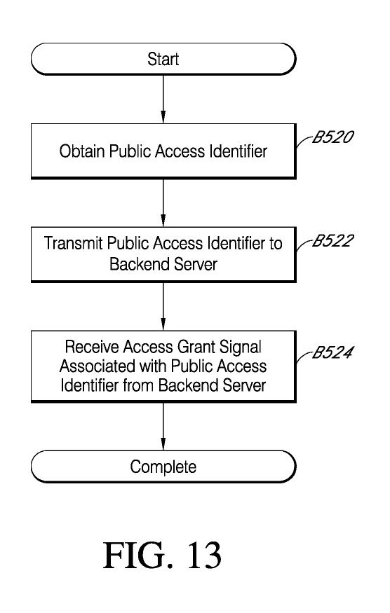

FIG. 13 is a flowchart illustrating a process for accessing video footage by a client device 114 using a public access identifier according to various aspects of the present disclosure. As discussed above, any member of the public may desire to access data captured by one or more of the security cameras 100. The process may include a first person obtaining (block B520) the public access identifier corresponding to a first one of the publicly-accessible security cameras 100 that the first person desires to access. As described above, the first public access identifier may be posted adjacent to the first security camera 100. In some embodiments, the first public access identifier may be available in one or more other locations, such as via a web interface, in addition to or instead of being posted adjacent to the first security camera 100. For example, a computer application executing on the client device 114 may display a map indicating the location of the first security camera 100 and the first public access identifier associated with the first security camera 100. Further, in various embodiments, there may be a plurality of security cameras 100 that each have their own unique public access identifier. These public access identifiers may be posted adjacent to their respective security cameras 100 and/or available in one or more other locations, such as via a web interface.

Once the first person has obtained the first public access identifier associated with the first security camera 100, the process may further include transmitting (FIG. 13, block B522) the first public access identifier to the backend server 118 using the client device 114. For example, the first person may input the first public access identifier into a computer application executing on the client device 114, and the client device 114 may transmit the first public access identifier to the backend server 118. Upon receiving the first public access identifier from the client device 114, the backend server 118 may grant or deny access to the image data (and/or audio data), as further described below. Upon grant of access by the backend server 118, the client device 114 may receive (block B524) an access grant signal associated with the transmitted first public access identifier. In some embodiments, the access grant signal may also include a notification of grant of access to video footage (and, in some embodiments, audio) recorded by the security camera 100. In some embodiments, the client device 114 may be configured to receive (e.g., from the backend server 118) a plurality of links to a plurality of video clips recorded by the security camera 100. The client device 114 may also receive a playback request (e.g., a user input) to play one of the plurality of video clips. Further, the client device 114 may be configured to transmit the playback request to the backend server 118 to play a selected one of the plurality of video clips, and the client device 114 may receive from the backend server 118 streaming video corresponding to the selected one of the plurality of video clips. In some embodiments, the client device 114 may be configured to receive a user input to share the streaming video with other users and/or with law enforcement.

In some embodiments, a computer application executing on the client device 114 may prompt the user to select one or more additional cameras to which the user desires access. For example, when the user requests access to a first camera, such as by inputting the public access identifier associated with the first camera into the computer application executing on the client device 114, the computer application may then display a map of the area surrounding the first camera. The displayed map may identify the location(s) of one or more other publicly-accessible cameras. The computer application may prompt the user to select one or more of the identified cameras on the map. If the user selects one of the cameras on the map, the application may grant the user access to the selected camera, or may ask the user to confirm that he or she desires access to the selected camera and, if the user confirms that he or she desires access to the selected camera, may then grant the user access to the selected camera. The selection process may then be repeated one or more times as desired until the user has selected all of the cameras to which he or she desires access.

The client device 114 may be configured to transmit to the backend server 118 an alert request to receive an alert whenever motion is detected within the field of view of a security camera 100 to which the user has requested access. When an alert is received, the client device 114 may then receive a user input to answer the alert. In response to the user input to answer the alert, the client device 114 may receive from the backend server 118 live streaming video. In some embodiments, the live streaming video may be transmitted from the backend server 118 to the client device 114 concurrently with the alert. If the user answers the alert, the live streaming video may continue to be transmitted from the backend server 118 to the client device 114. If, however, the user ignores the alert, the live streaming video may cease, such as after a timer expires, for example.

In some embodiments, the client device 114 may be further configured to receive a user input to share the live-streamed video with one or more other users and/or with law enforcement. For example, a computer application executing on the client device 114 may include a share option, such as a button or a prompt. If the user selects the share option, he or she may be guided through one or more steps to complete the share process, such as selecting one or more parties with whom to share the live-streamed video. The parties to receive the shared video may include one or more users and/or one or more law enforcement agencies. The share process may further include additional features or steps, such as an option to include comments with the shared video.

In some embodiments, the client device 114 may transmit to the backend server 118 an alert request to receive an alert when a person of interest is detected by the security camera 100. In such embodiments, the client device 114 may receive, from the backend server 118, the alert when the person of interest is detected by the security camera 100. Further, the client device 114 may receive a user input to answer the alert, and may then receive live streaming video from the backend server 118 in response to the user input to answer the alert. In some embodiments, the live streaming video may be transmitted from the backend server 118 to the client device 114 concurrently with the alert. If the user answers the alert, the live streaming video may continue to be transmitted from the backend server 118 to the client device 114. If, however, the user ignores the alert, the live streaming video may cease, such as after a timer expires, for example. In some embodiments, the client device 114 may again be configured to receive a user input to share the live-streamed video with one or more other users and/or with law enforcement. For example, a computer application executing on the client device 114 may include a share option, such as a button or a prompt. If the user selects the share option, he or she may be guided through one or more steps to complete the share process, such as selecting one or more parties with whom to share the live-streamed video. The parties to receive the shared video may include one or more users and/or one or more law enforcement agencies. The share process may further include additional features or steps, such as an option to include comments with the shared video.

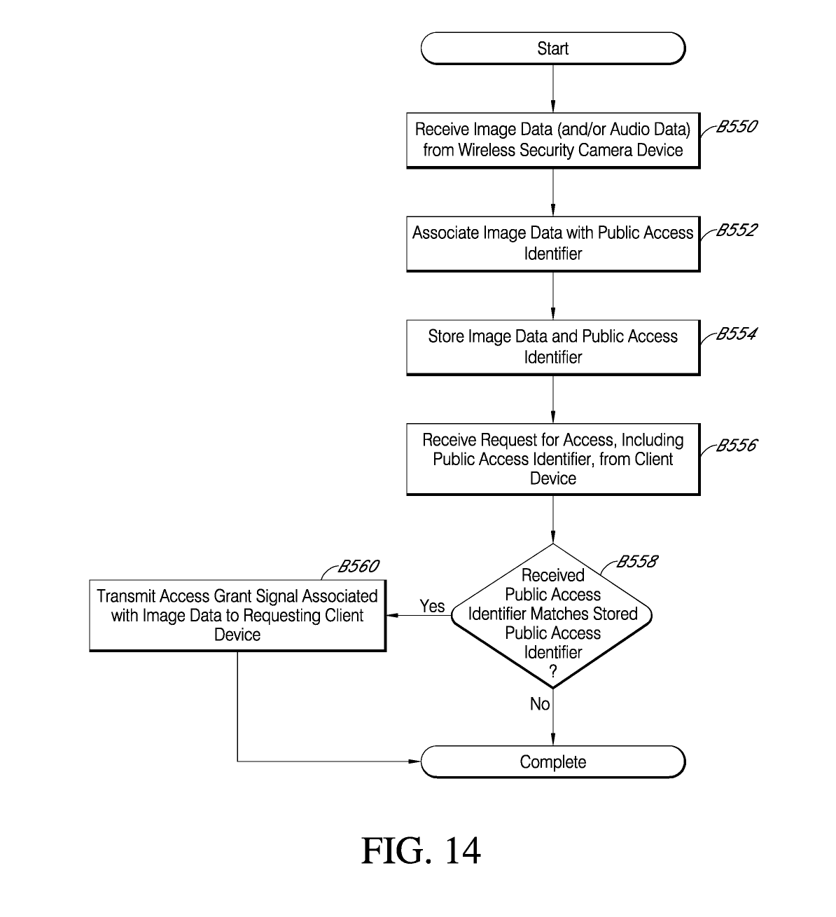

FIG. 14 is a flowchart illustrating a process for granting access, by a backend server 118, to video footage captured by a security camera 100 according to various aspects of the present disclosure. The process may include receiving (block B550) image data (and, in some embodiments, audio data) from a security camera 100, as described above. In some embodiments, the image data may be stored at the backend server 118 and/or the storage device 116. Upon receiving the image data, the backend server 118 may associate (block B552) the received image data with a public access identifier. In some embodiments, the public access identifier may be received from the security camera 100 along with the image data. In other embodiments, the public access identifier may be deciphered by the backend server 118 using any identifying data corresponding to a particular publicly-accessible security camera 100. For example, the security camera 100 may have been assigned a public access identifier upon initial setup, which may have included one or more administrators providing identifying data corresponding to the security camera 100, such as (but not limited to) a street address, a GPS (Global Positioning System) location, and/or an IP (Internet Protocol)-based location associated with the security camera 100. In various embodiments, the backend server 118 may be able to associate received image data to a public access identifier based upon such identifying data deciphered from the received image data.

In further reference to FIG. 14, the process may further include storing (block B554) the received image data and the associated public access identifier. In some embodiments, the backend server 118 may process the received image data to generate video clips and/or video streams of video footage captured by the security camera 100. In further embodiments, the backend server 118 may also generate web-based links to the video clips and/or video streams.

In continued reference to FIG. 14, in some embodiments, the backend server 118 may receive (block B556) a request for access from a client device 114, where the request for access includes a public access identifier. Upon receiving the request for access, the backend server 118 may determine (block B558) if the received public access identifier matches a stored public access identifier. If there is a match, then the backend server may transmit (block B560), to the requesting client device 114, an access grant signal corresponding to the image data associated with the matched public access identifier. However, if there is not a match, then the process may terminate. As discussed above, the access grant signal may include a notification of grant of access to the video footage recorded by the security camera 100. In some embodiments, the access grant signal may include a plurality of links to a plurality of video clips recorded by the security camera 100. Further, the backend server 118 may receive from the client device 114 a playback request to play a selected one of the video clips. The backend server 118 may then send to the client device 114 streaming video corresponding to the selected one of the video clips.

As described above, in some embodiments the backend server 118 may receive from the client device 114 an alert request to receive an alert whenever motion is detected within a field of view of the security camera 100. The backend server 118 may further transmit to the client device 114 the alert whenever motion is detected within the field of view of the security camera 100. In further embodiments, the backend server 118 may receive from the client device 114 an alert request to receive an alert when a person of interest is detected by the security camera 100. The backend server 118 may also send to the client device 114 the alert when a person of interest is detected by the security camera 100. In addition, the backend server 118 may receive from the client device 114 a request to answer the alert and transmit to the client device 114 streaming video in response to the request to answer the alert. In some embodiments, the backend server 118 may receive information about a person of interest. Such information about a person of interest may include (but is not limited to) a photograph of the person of interest, and the photograph (and/or other identifying information) may be provided by the client device 114 that requested to receive an alert when the person of interest is detected by the security camera 100.

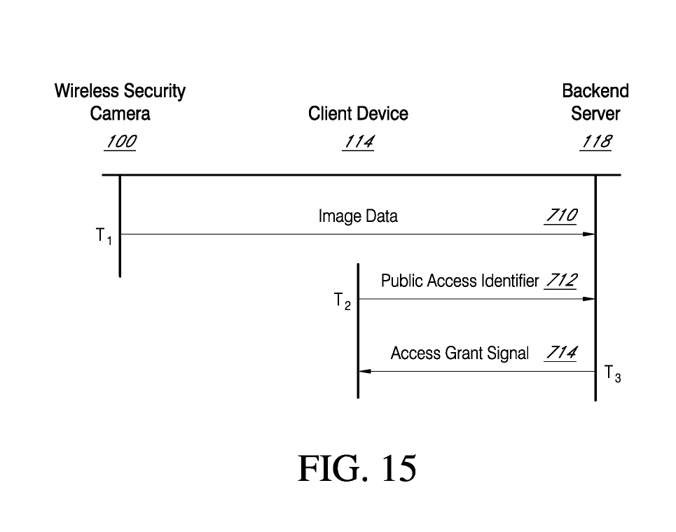

FIG. 15 is a sequence diagram illustrating an embodiment of a process for providing public access to video footage using a public access identifier according to various aspects of the present disclosure. With reference to FIG. 15, the process may include a security camera 100, a client device 114, and a backend server 118. In such embodiments, at a time T₁, the security camera 100 may transmit a first signal 710 comprising image data to the backend server 118. Prior to transmitting the first signal 710, the security camera 100 may be configured to capture image data and provide an access identifier to the public, as discussed above. At a time T₂, the client device 114 may transmit a second signal 712 comprising a public access identifier obtained from a publicly-accessible security camera 100 (or a web interface or other source), as discussed above. In some embodiments, time T₂ may be after time T₁, while in other embodiments time T₂ may substantially coincide with time T₁ (e.g., the first signal 710 and the second signal 712 may be transmitted at substantially the same time). After receiving the second signal 712, the backend server 118 may transmit an access grant signal 714 to the client device 114 at a time T₃ upon matching the received public access identifier with a stored public access identifier, as discussed above. Likewise, the client device 114 may receive the transmitted access grant signal 714 from the backend server 118. In various embodiments, the access grant signal 714 may be transmitted to, and received by, at least one other client device 114 in addition to, or instead of, the client device 114 that transmitted the second signal 712 to the backend server 118.

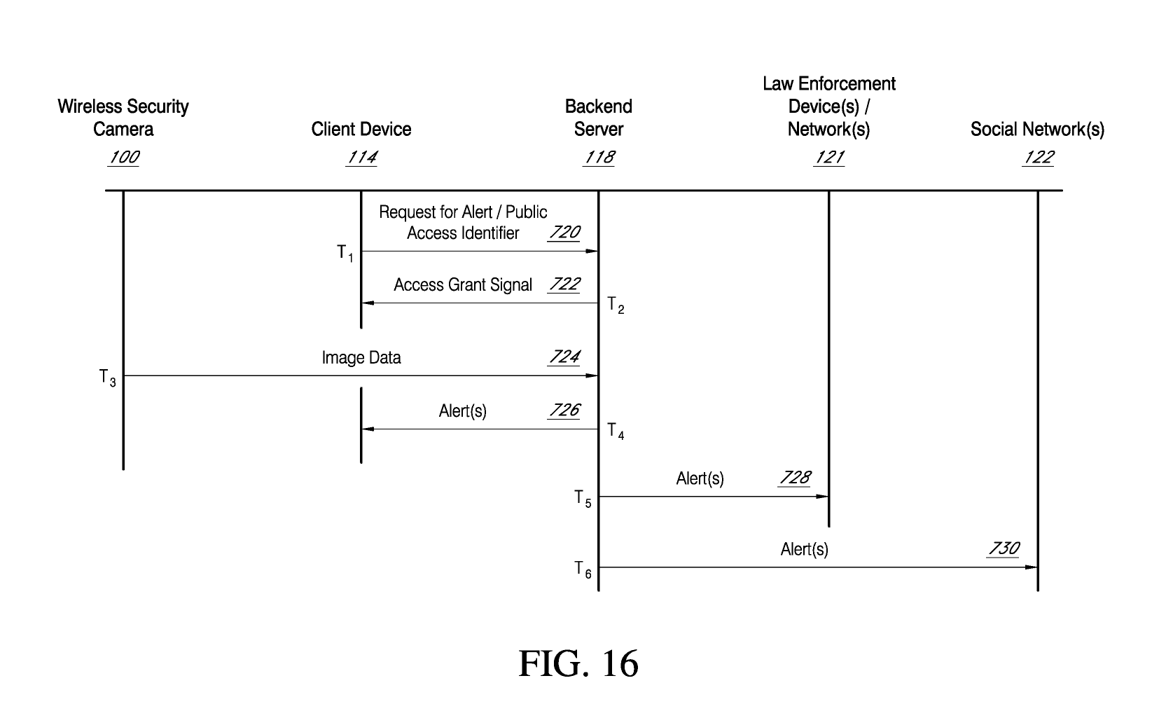

FIG. 16 is a sequence diagram illustrating an embodiment of a process for providing alerts using a publicly-accessible security camera according to various aspects of the present disclosure. With reference to FIG. 16, the process may include a security camera 100, a client device 114, and a backend server 118. In some embodiments, the process may also include at least one law enforcement device/network 121 and/or at least one social network 122. In such embodiments, at a time T₁, the client device 114 may transmit a first signal 720 comprising a request for alerts along with a public access identifier obtained from a publicly accessible security camera 100 (or a web interface or other source), as discussed above. After receiving the first signal 720, the backend server 118 may transmit an access grant signal 722 to the client device 114 at a time T₂ upon matching the received public access identifier with a stored public access identifier, as discussed above. Likewise, the client device 114 may receive the transmitted access grant signal 722 from the backend server 118. In various embodiments, the access grant signal 722 may be transmitted to, and received by, at least one other client device 114 in addition to, or instead of, the client device 114 that transmitted the first signal 720 to the backend server 118.

At a time T₃, the security camera 100 may transmit a third signal 724 comprising image data to the backend server 118. Prior to transmitting the third signal 724, the security camera 100 may be configured to capture image data, as discussed above. After receiving the first and third signals 720, 724, the backend server 118 may transmit an alert 726 to the client device 114 at a time T₄, as discussed above. Likewise, the client device 114, may receive the transmitted alert 726 from the backend server 118. In various embodiments, the alert 726 may be transmitted to, and received by, at least one other client device 114 in addition to, or instead of, the client device 114 that transmitted the first signal 720 to the backend server 118. At a time T₅, the backend server 118 may transmit an alert 728 to the law enforcement device(s)/network(s) 121, and at a time T₆ the backend server 118 may transmit an alert 730 to the social network(s) 122. In some embodiments, times T₄, T₅, and T₆ may substantially coincide with one another (e.g., the alerts 726, 728, 730 may be transmitted at substantially the same time). In other embodiments, times T₄, T₅, and T₆ may not coincide with one another, and the alerts 726, 728, 730 may be transmitted in any relative order.

The present embodiments provide numerous advantages and improve the functionality of security cameras in several ways. For example, the present security cameras are accessible to the public. Any member of the public can request access to the entire video history of the present security cameras, and any member of the public can request to receive alerts from the present security cameras. The present security cameras thus expand the audience for viewing security camera video footage, thereby increasing the likelihood that persons committing crimes in view of the present security cameras will be identified and apprehended. The present security cameras also enable members of the public to provide information about a person of interest and to receive alerts when the person of interest is detected by the security cameras. This aspect increases public safety as compared to prior security cameras by raising awareness when potentially dangerous persons are in the vicinity.

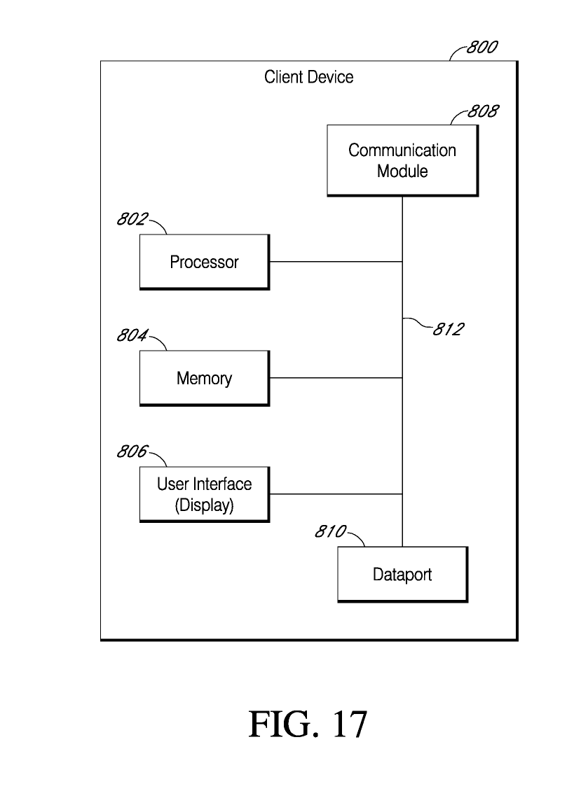

FIG. 17 is a functional block diagram of a client device 800 on which the present embodiments may be implemented according to various aspects of the present disclosure. The user's client device 114 described with reference to FIG. 1 may include some or all of the components and/or functionality of the client device 800. The client device 800 may comprise, for example, a smartphone.

With reference to FIG. 17, the client device 800 includes a processor 802, a memory 804, a user interface 806, a communication module 808, and a dataport 810. These components are communicatively coupled together by an interconnect bus 812. The processor 802 may include any processor used in smartphones and/or portable computing devices, such as an ARM processor (a processor based on the RISC (reduced instruction set computer) architecture developed by Advanced RISC Machines (ARM)). In some embodiments, the processor 802 may include one or more other processors, such as one or more conventional microprocessors, and/or one or more supplementary co-processors, such as math co-processors. Further, in some embodiments, the client device 800 may comprise a processing module (not shown) including the processor 802 and a security camera application (not shown).

The memory 804 may include both operating memory, such as random access memory (RAM), as well as data storage, such as read-only memory (ROM), hard drives, flash memory, or any other suitable memory/storage element. The memory 804 may include removable memory elements, such as a CompactFlash card, a MultiMediaCard (MMC), and/or a Secure Digital (SD) card. In some embodiments, the memory 804 may comprise a combination of magnetic, optical, and/or semiconductor memory, and may include, for example, RAM, ROM, flash drive, and/or a hard disk or drive. The processor 802 and the memory 804 each may be, for example, located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 802 may be connected to the memory 804 via the dataport 810.

The user interface 806 may include any user interface or presentation elements suitable for a smartphone and/or a portable computing device, such as a keypad, a display screen, a touchscreen, a microphone, and a speaker. The communication module 808 is configured to handle communication links between the client device 800 and other, external devices or receivers, and to route incoming/outgoing data appropriately. For example, inbound data from the dataport 810 may be routed through the communication module 808 before being directed to the processor 802, and outbound data from the processor 802 may be routed through the communication module 808 before being directed to the dataport 810. The communication module 808 may include one or more transceiver modules capable of transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, or any other protocol and/or technology.

The dataport 810 may be any type of connector used for physically interfacing with a smartphone and/or a portable computing device, such as a mini-USB port or an IPHONE®/IPOD® 30-pin connector or LIGHTNING® connector. In other embodiments, the dataport 810 may include multiple communication channels for simultaneous communication with, for example, other processors, servers, and/or client terminals.

The memory 804 may store instructions for communicating with other systems, such as a computer. The memory 804 may store, for example, a program (e.g., computer program code) adapted to direct the processor 802 in accordance with the present embodiments. The instructions also may include program elements, such as an operating system. While execution of sequences of instructions in the program causes the processor 802 to perform the process steps described herein, hard-wired circuitry may be used in place of, or in combination with, software/firmware instructions for implementation of the processes of the present embodiments. Thus, the present embodiments are not limited to any specific combination of hardware and software.

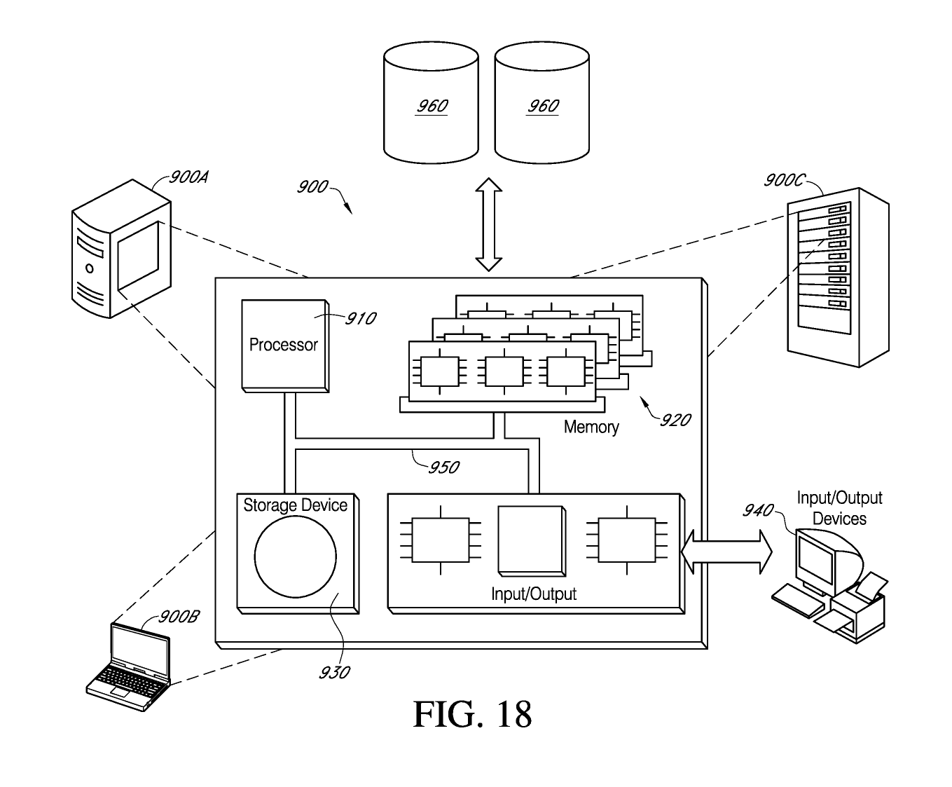

FIG. 18 is a functional block diagram of a general-purpose computing system on which the present embodiments may be implemented according to various aspects of the present disclosure. The computer system 900 may execute at least some of the operations described above. The computer system 900 may include at least one processor 910, memory 920, at least one storage device 930, and input/output (I/O) devices 940. Some or all of the components 910, 920, 930, 940 may be interconnected via a system bus 950. The processor 910 may be single- or multi-threaded and may have one or more cores. The processor 910 may execute instructions, such as those stored in the memory 920 and/or in the storage device 930. Information may be received and output using one or more I/O devices 940.

The memory 920 may store information, and may be a computer-readable medium, such as volatile or non-volatile memory. The storage device(s) 930 may provide storage for the system 900, and may be a computer-readable medium. In various aspects, the storage device(s) 930 may be a flash memory device, a hard disk device, an optical disk device, a tape device, or any other type of storage device.

The I/O devices 940 may provide input/output operations for the system 900. The I/O devices 940 may include a keyboard, a pointing device, and/or a microphone. The I/O devices 940 may further include a display unit for displaying graphical user interfaces, a speaker, and/or a printer. External data may be stored in one or more accessible external databases 960.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

To provide for interaction with a user, the features of the present embodiments may be implemented on a computer having a display device, such as an LCD (liquid crystal display) monitor, for displaying information to the user. The computer may further include a keyboard, a pointing device, such as a mouse or a trackball, and/or a touchscreen by which the user may provide input to the computer.

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A security camera device, comprising:
a camera having a field of view, the camera being configured to record image data of the field of view;
a communication module; and
a processing module operatively connected to the camera and to the communication module, the processing module comprising
a processor; and
a camera application, wherein the camera application configures the processor to
obtain the image data from the camera; and
transmit the image data to a backend server using the communication module, such that the image data is publicly accessible via the backend server;
wherein the security camera device is configured to provide a public access identifier for accessing, using a client device, the image data recorded by the camera and transmitted to the backend server.

2. The security camera device of claim 1, wherein the public access identifier comprises an alphanumeric code configured to be entered into an application executing on the client device.

3. The security camera device of claim 1, wherein the public access identifier comprises at least one form of automatic identification and data capture (AIDC).

4. The security camera device of claim 3, wherein the AIDC comprises at least one of a barcode, a matrix code, and a bokode.

5. The security camera device of claim 1, wherein the image data publicly accessible via the backend server comprises at least one of a live video stream from the camera and one or more video files recorded by the camera.

6. The security camera device of claim 1, further comprising a motion sensor configured to gather information from within the field of view of the camera and generate an output signal.

7. The security camera device of claim 6, wherein the camera application further configures the processor to receive the output signal from the motion sensor and determine, based on the output signal from the motion sensor, whether motion is indicated within the field of view of the camera, and to activate the camera when it is determined that motion is indicated within the field of view of the camera.

8. The security camera device of claim 1, wherein the camera application further configures the processor to perform automatic identification and data capture (AIDC).

9. The security camera device of claim 8, wherein the AIDC comprises at least one of biometrics, voice recognition, facial recognition, three-dimensional facial recognition, and skin texture analysis.

10. The security camera device of claim 8, wherein the camera application further configures the processor to generate an alert when a person of interest is detected using the AIDC.

11. The security camera device of claim 1, further comprising a housing configured to contain and protect the camera, the communication module, and the processing module.

12. The security camera device of claim 1, further comprising a solar panel configured to provide power to the security camera device.

13. The security camera device of claim 1, wherein the communication module is configured to transmit and receive signals wirelessly.

14. A method for granting access to video footage recorded by a publicly-accessible security camera device, the method comprising:
receiving, at a backend server from a client device, a request for access to the video footage recorded by the publicly-accessible security camera device, the request including a public access identifier corresponding to the publicly-accessible security camera device, wherein the public access identifier is posted adjacent the publicly-accessible security camera device in a public location; and
transmitting, by the backend server to the client device, an access grant signal with a notification of grant of access to the video footage recorded by the publicly-accessible security camera device.

15. The method of claim 14, further comprising transmitting, by the backend server to the client device, a plurality of links to a plurality of video clips recorded by the publicly-accessible security camera device.

16. The method of claim 15, further comprising receiving, by the backend server from the client device, a playback request to play a selected one of the plurality of video clips.

17. The method of claim 16, further comprising transmitting, by the backend server to the client device, streaming video corresponding to the selected one of the plurality of video clips.

18. The method of claim 14, further comprising receiving, by the backend server from the client device, an alert request to receive an alert when motion is indicated within a field of view of the security camera device.

19. The method of claim 18, further comprising transmitting, by the backend server to the client device, the alert when motion is indicated within the field of view of the security camera device.

20. The method of claim 14, further comprising receiving, by the backend server from the client device, an alert request to receive an alert when a person of interest is detected by the security camera device.

21. The method of claim 20, further comprising transmitting, by the backend server to the client device, the alert when the person of interest is detected by the security camera device.

22. The method of claim 21, further comprising receiving, by the backend server from the client device, a request to answer the alert.

23. The method of claim 22, further comprising transmitting, by the backend server to the client device, streaming video in response to the request to answer the alert.

24. The method of claim 20, further comprising receiving, by the backend server, information about the person of interest.

25. The method of claim 24, wherein the information about the person of interest comprises a photograph.
